(19) United States
(12) Patent Application Publication
(10) Pub. No.: US 2004/0259613 A1
(43) Pub. Date: Dec. 23, 2004

(54) Gaming machine and computer-readable program product

(75) Inventor: Matsuzo Machida, Tokyo (JP)

Correspondence Address: MCGINN & GIBB, PLLC, 8321 OLD COURTHOUSE ROAD, SUITE 200, VIENNA, VA, 22182-3817, US

(73) Assignee: Aruze Corp., Tokyo (JP)

(21) Appl. No.: 10/869,895

(22) Filed: Jun. 18, 2004

(30) Foreign Application Priority Data
Jun. 19, 2003 (JP) P2003-175620
Jun. 19, 2003 (JP) P2003-175622

(51) Int. Cl. A63F 13/00

(52) U.S. Cl. 463/1

(57) ABSTRACT

A gaming machine includes: an operation unit that allows the player to enter the action command; a display controller that displays a plurality of characters including the ally character and at least one enemy character on a display for displaying the progress of the game and displaying a battle between the ally character and the enemy character; and an enemy parameter storage that stores a parameter concerning the enemy character when the ally character encounters the enemy character and a predetermined condition is satisfied.

### CROSS-REFERENCE TO THE RELATED APPLICATION(S)

This application is based upon and claims a priority from prior Japanese Patent Applications No. 2003-175620 and No. 2003-175622 both filed on Jun. 19, 2003, the entire contents of which are incorporated herein by reference. This application is related to co-pending U.S. applications claiming priorities on JP-2003-175618, JP-2003-175623, JP-2003-175064, JP-2003-175065, JP-2003-175066, JP-2003-175136 and JP-2003-175137, and filed on even date herewith. The co-pending applications are expressly incorporated herein by reference.

### BACKGROUND OF THE INVENTION

1. Field of the Invention

The present invention relates to a gaming machine, a gaming program, and a record medium recording the gaming program and in particular to a gaming machine and a gaming program for displaying a plurality of characters on a display screen and allowing a player to select the action of the character, thereby advancing a game, and a record medium recording the gaming program.

2. Description of the Related Art

Hitherto, various games have been provided for a player to enter commands, etc., through operation unit such as a controller to handle a character in the game in a virtual world in the game on a screen of a computer, a television, etc., and advance a preset story. Such a game is generally called “RPG” (Role Playing Game).

The following RPG is generally known: A battle scene in which a character handled by a player, which will be hereinafter referred to as the main character, and an enemy character controlled by a computer fight a battle is included and the player beats the enemy character in the battle, thereby obtaining an experiment value or virtual money, and advances the story whiling raising the character level.

In some RPGs, when the player selects an attack command in a battle, a judgment ring involving a rotation bar is displayed and when the rotation bar passes through a timing area set in a predetermined angle range of the judgment ring, the player performs appropriate button operation, thereby making an effective attack.

In the battle scene in this kind of RPG, the attack made by the main character is uniquely determined by the attack power level, etc., based on the skill set for the main character and the possessed items (arms and spell). The action of the character after command selection is automatically processed by the computer in accordance with the action control algorithm of the character contained in the game program based on the selected command. The RPG enables the player to select a spell command for displaying the status of the enemy character, the opposite character in the battle, as a part of the attack command.

In some RPGs, for a character to take action of an attack using spell, the character may be transformed into a character having a more advantageous attribute, such as a dragon. Further, when the main character satisfies a predetermined condition, the main character may be able to be transformed into the enemy character.

A conventional gaming machine and computer program for providing the above described game is disclosed in JP-A-2002-200354.

### SUMMARY OF THE INVENTION

In such an RPG, for one character to be transformed into another character, special operation such as muttering spell words, is to be needed. However, the spell level that can be acquired and used by the character is determined by the character level of the character at the point in time. That is, unless the character level of the character rises for the character to obtain the spell level as for the spell words to transform the character into a dragon, etc., the character cannot use the spell words to transform itself into a dragon, etc. Therefore, the spell attack of the character transformed into a dragon, etc., is difficult to use from the beginning of a game and is not often taken and thus the effect of the action in the game becomes monotonous and it is feared that the player may get tired of the game.

In the RPG disclosed in JP-A-2002-200354, the main character cannot be transformed into the enemy character until the cumulative amount of the level of the trophy status that can be gained in battles reaches a predetermined value and the main character fights the special enemy character and wins the battle. Thus, it is impossible to often use the action of transforming the main character into the enemy character from the beginning of the game, the spell attack becomes monotonous, and it is feared that the player may get tired of the game.

The status to be displayed during the game contains important factors for attack, such as the hit points indicating the attack resistance of the opposite enemy character and a bonus item given to the main character when the main character beats the enemy character. However, the spell command for displaying the status is a part of the attack command and thus the status of the opposite character in attack is displayed after the attack is started. Therefore, the player finds during or after the battle that the profit is small when the enemy is beaten, and it is feared that the status may not be a guide for determining whether or not the battle is to be fought.

It is therefore an object of the invention to provide a gaming machine and a program product for making it possible to provide multifaceted action variations and effects, augment the interest in a game, and increase the interest of the player in a battle scene.

It is another object of the invention to provide a gaming machine and program product for making it possible for the player to select the enemy character having any desired bonus item for fighting a battle and intentionally select a battle manner from among options.

According to a first aspect of the invention, there is provided a gaming machine for allowing a player to enter an action command of an ally character to proceed a game, the gaming machine including: an operation unit that allows the player to enter the action command; a display controller that displays a plurality of characters including the ally character and at least one enemy character on a display for displaying the progress of the game and displaying a battle between the ally character and the enemy character; and an enemy parameter storage that stores a parameter concerning the enemy character when the ally character encounters the enemy character and a predetermined condition is satisfied.

According to a second aspect of the invention, there is provided a computer-readable program product for storing a gaming program for causing a computer to execute steps of: allowing a player to enter an action command of an ally character to proceed a game; displaying a plurality of characters including the ally character and at least one enemy character on a display for displaying the progress of the game and displaying a battle between the ally character and the enemy character; and storing a parameter concerning the enemy character in an enemy parameter table when the ally character encounters the enemy character and a predetermined condition is satisfied.

According to a third aspect of the invention, there is provided a gaming program that is executed by a computer including operation means operated by a player and a storage means that stores a parameter, for displaying a plurality of characters on a screen of an existing display or a separate display and determining an action for any of the plurality of characters in response to entry operation through the operation means to proceed a game on the screen, the gaming program for causing the computer to function as special skill giving means for storing a parameter of a skill belonging to a different character from the character whose action is determined according to predetermined entry operation through the operation means in the storage section as a special skill parameter; and action determination means for determining the action of the character using the special skill parameter stored in the storage section in response to entry operation through the operation means.

According to a fourth aspect of the invention, there is provided a gaming machine including: operation means that is operated by a player; and a machine main unit that displays a plurality of characters on a screen of an existing display or a separate display and determining an action for any of the plurality of characters in response to entry operation through the operation means to proceed a game on the screen, wherein the machine main unit includes: storage means for storing parameters of the characters; special skill giving means for storing a parameter of a technique belonging to a different character from the character whose action is determined according to predetermined entry operation through the operation means in the storage means as a special skill parameter; and action determination means for determining the action of the character using the special skill parameter stored in the storage means in response to entry operation through the operation means.

According to a fifth aspect of the invention, there is provided a computer-readable storage medium recording a gaming program that is executed by a computer including operation means that is operated by a player and a storage section that stores a parameter, for displaying a plurality of characters on a screen of an existing display or a separate display and determining an action for any of the plurality of characters in response to entry operation through the operation means to proceed a game on the screen, the gaming program for causing the computer to function as special skill giving means for storing a parameter of a technique belonging to a different character from the character whose action is determined according to predetermined entry operation through the operation means in the storage section as a special skill parameter; and action determination means for determining the action of the character using the special skill parameter stored in the storage section in response to entry operation through the operation means.

According to a sixth aspect of the invention, there is provided a gaming program that is executed by a computer including operation means that is operated by a player and a storage section that stores a parameter, for displaying an ally character and an enemy character on a screen of an existing display or a separate display and determining an action for the ally character in response to entry operation through the operation means to proceed a game on the screen, the gaming program including the steps of causing the computer to operate as action determination means for determining the action of the ally character in response to entry operation through the operation means; status parameter acquisition means for storing a parameter of the status of the enemy character in the storage section; and enemy character status display control means for displaying the status on the screen based on the parameter stored in the storage section as a predetermined condition is satisfied.

According to a seventh aspect of the invention, there is provided a gaming machine including: operation means that is operated by a player; and a machine main unit that displays an ally character and an enemy character on a screen of an existing display or a separate display and determining an action for the ally character in response to entry operation through the operation means to proceed a game on the screen, wherein the machine main unit includes: action determination means for determining the action of the ally character in response to entry operation through the operation means; status parameter storage means for storing a parameter of the status of the enemy character; and enemy character status display control means for displaying the status on the screen based on the parameter stored in the status parameter storage means as a predetermined condition is satisfied.

According to an eighth aspect of the invention, there is provided a computer-readable storage medium recording a gaming program that is executed by a computer including operation means that can be operated by a player for displaying an ally character and an enemy character on a screen of an existing display or a separate display and determining an action for the ally character in response to entry operation through the operation means to proceed a game on the screen, the gaming program comprising the steps of causing the computer to operate as action determination means for determining the action of the ally character in response to entry operation through the operation means; status parameter storage means for storing a parameter of the status of the enemy character; and enemy character status display control means for displaying the status on the screen based on the parameter stored in the status parameter storage means according to specific entry operation different from the entry operation.

### BRIEF DESCRIPTION OF THE DRAWINGS

These and other objects and advantages of the present invention will be more fully apparent from the following detailed description taken in conjunction with the accompanying drawings, in which:

FIG. 1 is a drawing to show the general configuration of a gaming machine incorporating the invention;

FIG. 2 is a block diagram to show the system configuration of the gaming machine in FIG. 1;

FIG. 3A shows an example of a title screen of the game provided by the gaming machine and FIG. 3B shows an example of a world map displayed in the game;

FIG. 4 is a flowchart to show a procedure of main game processing;

FIG. 5 is a flowchart to show a procedure of battle processing;

FIG. 6 is a drawing to show a battle scene start screen;

FIG. 7 is a flowchart to show a procedure of WP decrement processing;

FIGS. 8A and 8B are a drawing to show the character individual skills of main characters A and B, respectively;

FIG. 9 is a drawing to show a command selection screen;

FIG. 10 is a flowchart to show a procedure of command acceptance processing;

FIG. 11 is a flowchart to show a procedure of character out-of-control processing;

FIG. 12 shows a first display example when the character out-of-control processing is executed;

FIG. 13 shows a second display example when the character out-of-control processing is executed;

FIG. 14 is a flowchart to show a procedure of command processing;

FIG. 15 is a flowchart to show a procedure of judgment processing;

FIG. 16 is a drawing to show a target character selection screen;

FIG. 17 is a drawing to show a display screen at the command determination time;

FIG. 18 is a drawing to show a screen displayed when an O button is operated when a rotation bar passes through a first timing area;

FIG. 19 is a drawing to show a screen displayed when the O button is operated when the rotation bar passes through a second timing area;

FIG. 20 is a drawing to show a screen displayed when the O button is operated when the rotation bar passes through a third timing area;

FIG. 21 is a drawing to show a screen displayed when a player fails in operating the O button on the timing area;

FIG. 22 is a drawing to show a screen displayed after rotation of the rotation bar stops when a player succeeds in operating the O button on all timing areas;

FIG. 23 is a drawing to show how the main character A attacks an enemy character A;

FIG. 24 is a drawing to show a screen displayed when the main character A terminates the attack on the enemy character A and returns to the former position;

FIG. 25 is a flowchart to show a procedure of judgment ring determination processing;

FIG. 26 is a drawing to show an arm table;

FIG. 27.is a drawing to show a calculation expression for calculating the damage amount to an enemy character (opposite character damage amount);

FIG. 28 is a drawing to show the display mode of a judgment ring displayed at the command determination time;

FIG. 29 is a drawing to show the displaymode of the judgment ring after the command determination;

FIGS. 30A and 30B are drawings to show different examples of 120% areas;

FIG. 31 is a drawing to show a special table;

FIG. 32A is a drawing to show a calculation expression for calculating the opposite character damage amount when attack spell is used and FIG. 32B is a drawing to show a calculation expression for calculating the recovery value when recovery spell is used;

FIG. 33 is a drawing to show an item table;

FIG. 34 is a drawing to show a judgment ring correction parameter table;

FIG. 35 is a flowchart to show a procedure of judgment ring decision processing;

FIG. 36 is a flowchart to show a procedure of soul point addition processing;

FIG. 37 is a drawing to show a soul point table;

FIGS. 38A and 38B are drawings to show a acquired-number-of-soul-points display screen;

FIG. 39 is a drawing to show an example of the number of soul points required for raising the fusion level;

FIG. 40 is a drawing to show how a graveyard is displayed;

FIG. 41 is a flowchart to show a procedure of GRAVEYARD command processing;

FIG. 42 is a drawing to show how a fusion monster appears in the graveyard;

FIG. 43 is a drawing to show a fusion soul get screen;

FIG. 44 is a drawing to show a monster table;

FIG. 45 is a drawing to show a picture book table;

FIG. 46 is a flowchart to show a procedure of menu display processing;

FIG. 47 is a drawing to show a screen of a monster picture book

FIG. 48 is a drawing to show how main character A attacks an enemy character as a SUMMON command is selected;

FIG. 49 is a flowchart to show a procedure of HP display processing;

FIG. 50 is a drawing to show that parameters of enemy characters are displayed as the HP display processing is performed;

FIG. 51 is a drawing to show that parameters of enemy characters are displayed as the HP display processing is performed; and

FIG. 52 is a drawing to show the configuration of a network game system.

### DETAILED DESCRIPTION OF THE PREFERRED EMBODIMENTS

Referring now to the accompanying drawings, a description will be given in detail of a preferred embodiment of the invention.

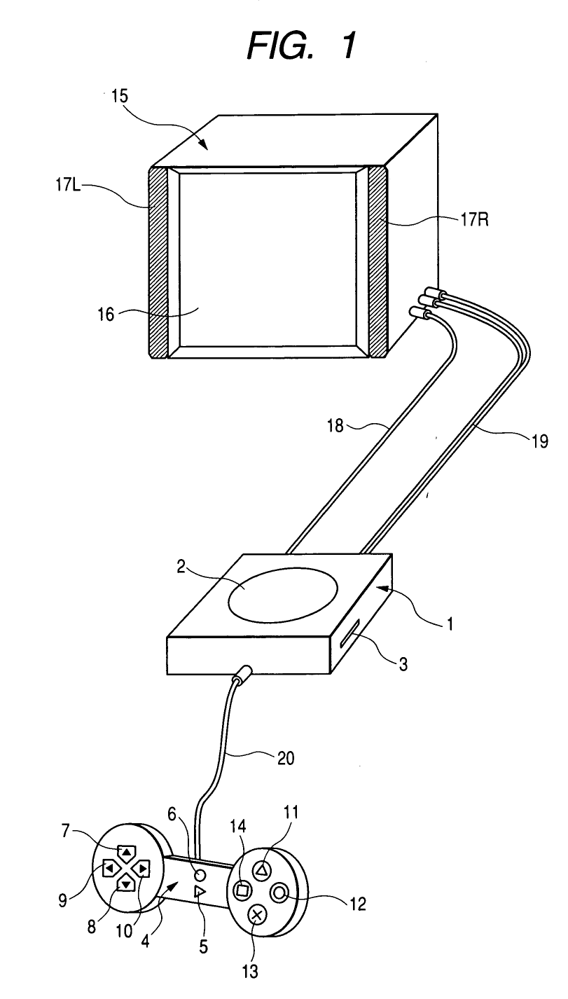

FIG. 1 shows the general configuration of a gaming machine incorporating the invention. The gaming machine includes a machine main unit 1, a controller 4 as operation for outputting a control command to the machine main unit 1 in response to operation of a player, and a display 15 for displaying an image based on an image signal from the machine main unit 1. In the gaming machine, a game is executed as various images are displayed on a display surface (screen) 16 of the display 15 such as a CRT.

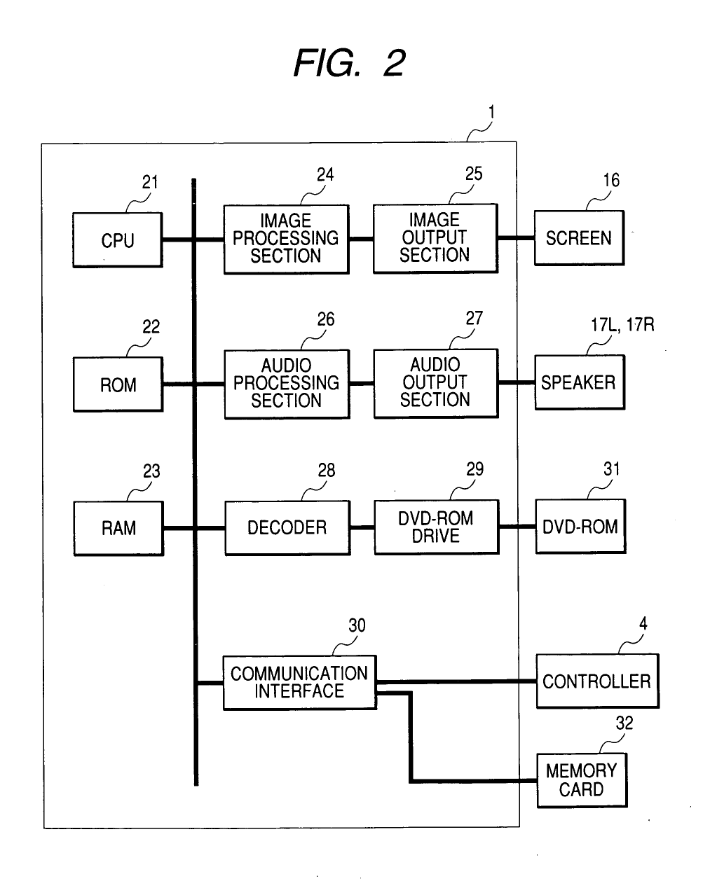

A game executed in the gaming machine is executed as a gaming program recorded on an external record medium separate from the machine main unit 1 is read. In addition to a CD-ROM or a DVD-ROM, an FD (flexible disk) or any other record medium can be used as the external record medium recording the gaming program. In the embodiment, a DVD-ROM is used as the external record medium. A cover 2 that can be opened and closed is provided in the top center of the machine main unit 1. As the cover 2 is opened, a DVD-ROM 31 can be placed in a DVD-ROM drive 29 (FIG. 2) as a record medium drive provided inside the machine main unit 1.

The controller 4 includes various input parts for outputting a control command to a CPU 21 (FIG. 2) in the machine main unit 1 in response to operation of the player. The controller 4 is provided in the left portion with an up button 7, a down button 8, a left button 9, and a right button 10 mainly operated by the player to move a character in a game or move an option of a menu as the input parts. The controller 4 is provided in the right portion with a Δ button 11, a O button 12, a X button 13, and a ▭ button 14 mainly operated by the player to determine or cancel various items. The controller 4 is provided in the center with a selection button 6 at the top and a start button 5 at the bottom.

The display 15 has input terminals of a video signal and an audio signal, which are connected to a video output terminal and an audio output terminal of the machine main unit 1 by terminal cables 18 and 19. Used as the display 15 is an existing television having in one piece the screen 16 that can display image data output from an image output section 25 (FIG. 2) described later and speakers 17L and 17R that can output audio data output from an audio output section 27 (FIG. 2) described later. The machine main unit 1 and the controller 4 are connected by a signal cable 20 as shown in FIG. 1.

The machine main unit 1 is provided on one side with a memory slot 3 as an insertion slot of a memory card 32 (FIG. 2). The memory card 32 is a storage medium for temporarily recording game data when the player interrupts the game, etc. The data recorded on the memory card 32 is read through a communication interface 30 (FIG. 2) described later having a card reader function.

Electric Configuration

FIG. 2 shows the system configuration of the gaming machine. The machine main unit 1 includes the CPU 21 as control means, ROM 22 and RAM 23 as storage means, an image processing section 24, the image output section 25, an audio processing section 26, the audio output section 27, a decoder 28, the DVD-ROM drive 29, and the communication interface 30.

The DVD-ROM 31 can be attached to and detached from the DVD-ROM drive 29 and the gaming program in the DVD-ROM 31 placed in the DVD-ROM drive 29 is read by the CPU 21 in accordance with a basic operation program of an OS (operating system), etc., stored in the ROM 22. The read gaming program is converted into predetermined signals by the decoder 28 for storage in the RAM 23.

The gaming program stored in the RAM 23 is executed by the CPU 21 in accordance with the basic operation program or an input signal from the controller 4. Image data and audio data are read from the DVD-ROM 31 in response to the executed gaming program. The image data is sent to the image processing section 24 and the audio data is sent to the audio processing section 26.

The image processing section 24 converts the received image data into an image signal and supplies the image signal to the screen 16 through the image output section 25. The audio processing section 26 converts the received audio data into an audio signal and supplies the audio signal to the speakers 17L and 17R through the audio output section 27.

The communication interface 30 enables the controller 4 and the memory card 32 to be connected detachably to the machine main unit 1. Through the communication interface 30, data is read from and written into the memory card 32 and a signal from the controller 4 is sent to the sections of the CPU 21, etc.

Next, specific examples of processing executed by the CPU 21 based on the gaming program recorded on the DVD-ROM 31 and the game content displayed on the screen 16 as the processing is executed will be discussed.

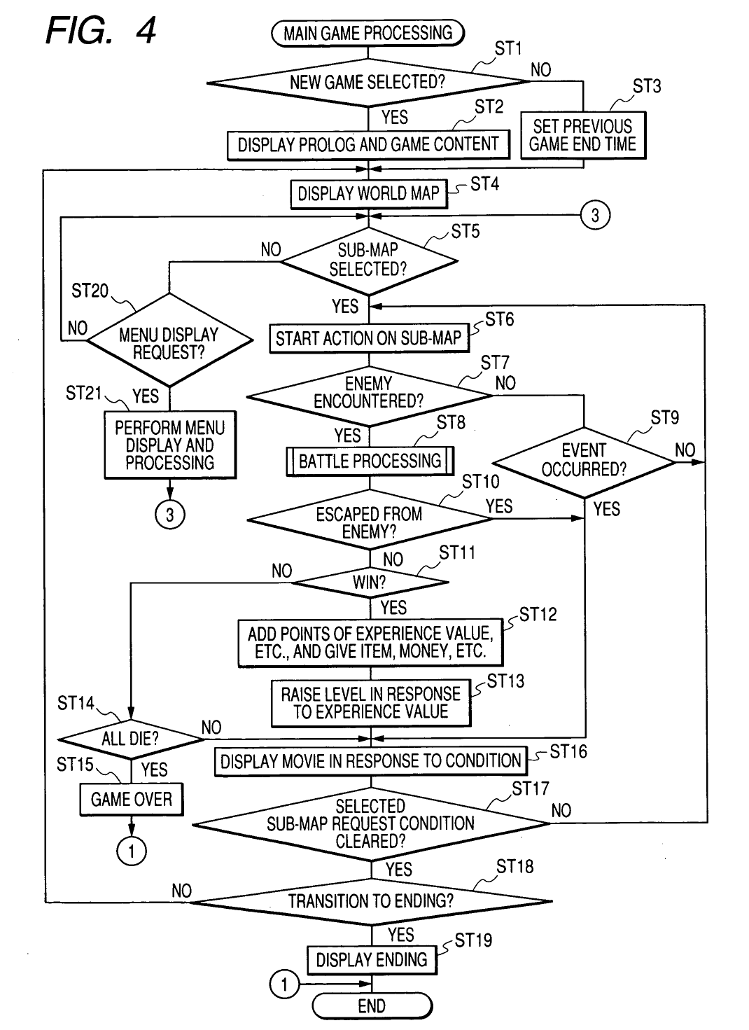

When power of the machine main unit 1 is on, when the DVD-ROM 31 is placed in the DVD-ROM drive 29, “opening demonstration” is displayed on the screen 16. The “opening demonstration” is effect display for telling the player about the start of a game. After the “opening demonstration” is displayed for a predetermined time, a “title screen” drawing a game title large is displayed and “main game processing” shown in FIG. 4 is started.

Title Screen

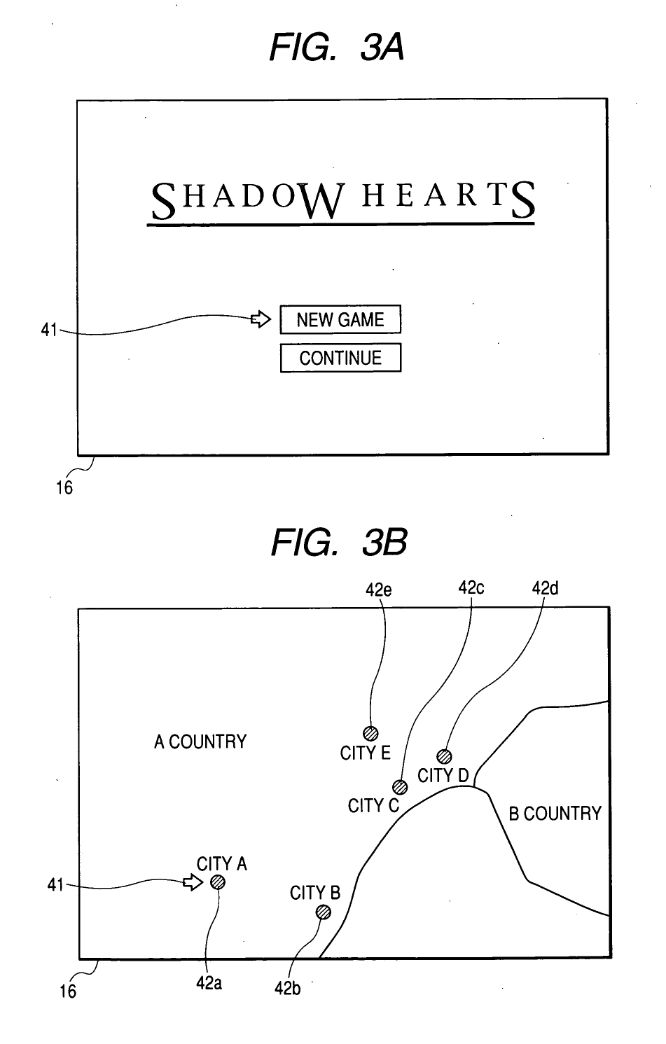

FIG. 3A shows an example of the “title screen.” Here, the character string of the game title, SHADOW HEARTS, is displayed and two options (NEW GAME and CONTINUE) are displayed below the game title. A cursor 41 is displayed at the left position of the option of either NEW GAME or CONTINUE and as the player operates the up button 7 or the down button 8, the position of the cursor 41 is changed. When the player operates the O button 12, the option pointed to by the cursor 41 for selection is selected.

In the “main game processing” shown in FIG. 4, first, which of the two options is selected on the title screen is determined (ST1). If it is determined that NEW GAME is selected (YES at ST1), a prolog and the game content are displayed (ST2) and then a “world map” shown in FIG. 3B is displayed (ST4). On the other hand, if it is determined that CONTINUE is selected (NO at ST1), the situation at the previous game end time is set to restore the state of the game (ST3), and then the “world map” is displayed without displaying the prolog or the game content (ST4).

As the game according to the embodiment, a main character of an ally character which acts based on operation of the player and an enemy character which acts based on the gaming program appear and a game developed centering on the battle between the characters is realized on the screen 16. In the embodiment, three main characters, namely, a main character A 111, a main character B 112, and a main character C 113 appear and the game proceeds in the party unit made up of the three main characters. Various types of status are set for each character. The experience value, money, arms, skill, and the like added by the number of gaming times, the number of times an enemy character has been beaten, etc, are defined as the status.

FIG. 3B shows an example of “world map.” The main cities of “A country” as the stage of the game story are displayed on the “world map” and options indicated by five city names (CITY A 42a, CITY B 42b, CITY C 42c, CITY D 42d, and CITY E 42e) are displayed. They are options to make a transition to a provided “sub-map.” As the player operates the up button 7 or the down button 8, the cursor 41 indicating each option moves and as the player operates the O buttton 12, one option is selected. When one “sub-map” is thus selected, the “world map” makes a transition to the screen corresponding to the “sub-map” and the player can play various games set in response to the “sub-map.” Specifically, the visual scene in each city is prerender-displayed as a background image conforming to scene development and while the main characters move therein, various events are conquered and the story proceeds.

When the player operates the □ buttton 14 on the “world map,” a “menu screen” is displayed, enabling the player to make various settings, etc., on the “menu screen.”

Main Game Processing

Referring again to FIG. 4, when any of the options displayed on the “world map” is selected (YES at ST5), a start screen of the “sub-map” responsive to the selected option is displayed and the party of the main characters starts action on the “sub-map” (ST6). On the other hand, when the determination at ST5 is NO, whether or not the player operates the □ buttton 14 on the “world map” for making a “menu screen” display request is determined (ST20). When the determination at ST20 is YES, the “menu screen” is displayed and various types of setting processing responsive to operation of the player are performed (ST21), and the process returns to ST5. The action on the “sub-map” is for the main character to walk, talk to a pedestrian, do shopping, etc. The player can also display the “menu screen” by operating the □ button 14 on the “sub-map” and various types of operation are made possible. For example, as the player selects a TOOL command, “TOOL command processing” described later is executed and the skill of an ally character can be recovered; as the player selects a TRADE command, trade processing described later is executed and it is made possible to sell a possessed item.

Then, when the main character party starting action on the “sub-map” encounters an enemy character (YES at ST7), “battle processing” is started (ST8). When the “battle processing” is started, a transition is made to a “battle scene” where a battle is fought between the main character party and the enemy character. The “battle processing” is described later. On the other hand, when the main character party does not encounter an enemy character (NO at ST7), when some event occurs (YES at ST9), the process goes to ST16 and a movie responsive to the event is displayed; when no event occurs (NO at ST9), the process returns to ST6.

In the “battle scene” executed by performing the “battle processing,” when the main character party succeeds in escaping from the enemy character (YES at ST10), the process goes to ST16 and a movie responsive to the situation is displayed. On the other hand, when the main character party fails in escaping from the enemy character or the main character party fights a battle with the enemy character (NO at ST10), subsequently whether or not the main character party wins the enemy character in the battle in the “battle scene” is determined (ST11). When the determination is YES, namely, when the main character party wins the enemy character, points of the experience value, etc., are added and an item and money are given to each character of the party in response to the type of enemy character and the battle substance (ST12). The level of each character is raised in response to the experience value of the character (ST13). Then, a movie responsive to the situation is displayed (ST16). When the determination at ST11 is NO, namely, when the main character party cannot win the enemy character, subsequently whether all characters of the main character party die is determined (ST14). When the determination is NO, the process goes to ST16. When the determination at ST14 is YES, the game is over (ST15) and the main game processing is terminated.

After a movie is displayed at ST16, when the sub-map request condition is cleared, (YES at ST17), subsequently whether or not a transition is to be made to the ending is determined (ST18). If the determination at ST18 is YES, a predetermined ending is displayed and the “main game processing” is terminated. On the other hand, if the determination at ST18 is NO, the process returns to ST4 and the game is continued.

Battle Processing

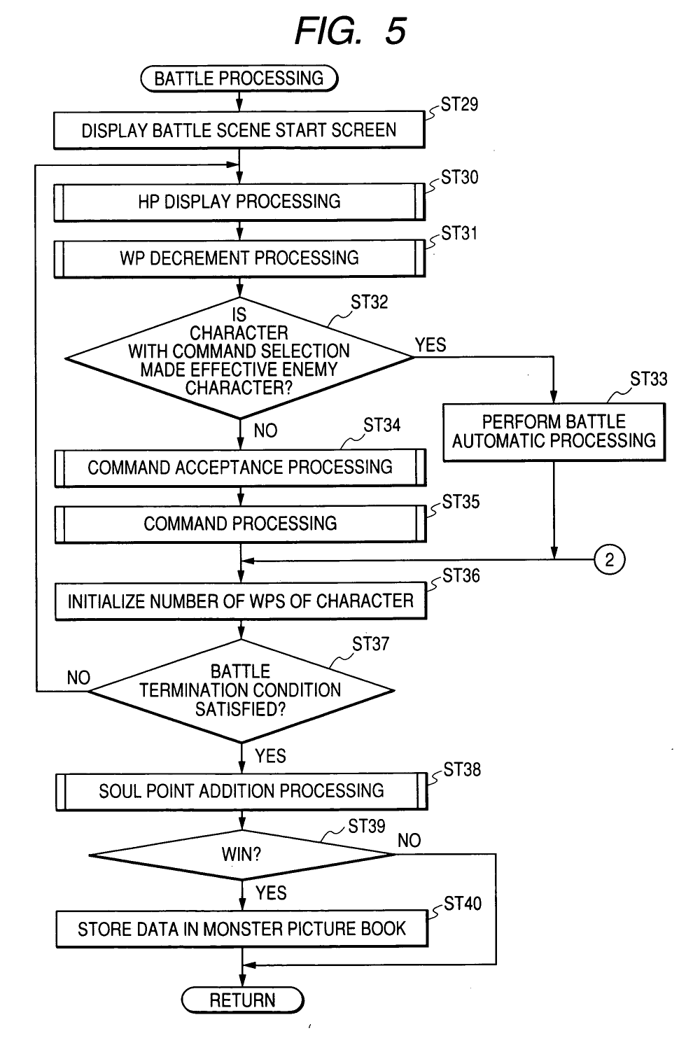

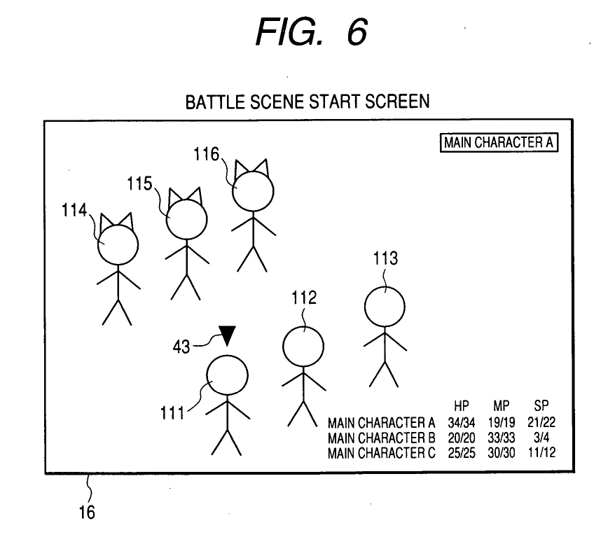

FIG. 5 shows a procedure of the “battle processing.” First, a “battle scene” start screen as shown in FIG. 6 is displayed (ST29). On the start screen, the main character party (main character A 111, main character B 112, main character C 113, and main character D 117) are displayed toward the player and three enemy characters (enemy character A 114, enemy character B 115, and enemy character C 116) are displayed facing the main character party. Information concerning the status of each main character is displayed in the lower right portion of the start screen. Specifically, hit points (HP), magic (spell) points (MP), and sanity points (SP) are predetermined for each main character, and the remaining numbers of points (current number of points/initial number of points) are displayed on the start screen. As HP remains, the main character can execute various commands of action determination, item use, etc., and when HP becomes zero, the corresponding main character becomes inactive. MP enables the corresponding main character to use a special skill of spell, etc., and when MP becomes zero, the main character becomes unable to use the special skill. SP enables the corresponding main character to hold its sanity. When SP becomes zero, the main character loses its sanity and enters an abnormal status. When the main character enters the abnormal status, command manipulation for the main character becomes ineffective and the main character runs away so as to take abnormal action in such a manner that it makes an attack on any character regardless of whether the character is an enemy or an ally.

Next, “HP display processing” for displaying the HP of an enemy character is performed (ST30). As the “HP display processing” is performed, the HP about the enemy character with which the main character fights a battle is displayed for use as material to determine labor required for fighting a battle with the enemy character and merits. However, the HP of the enemy character is displayed only when the main characters contain a special character. The “HP display processing” is described later in detail.

Next, “WP decrement processing” to decrement wait points (WP) for managing the order in which the main characters and enemy characters can take action of attack, etc., based on a predetermined condition is performed (ST31). In the WP decrement processing,” as for the main characters, the action order of the characters to make command selection of the player effective is managed. The “WP decrement processing” is described later in detail.

Whether or not the character for which command selection is made effective in the “WP decrement processing” (the character whose turn has come around) is an enemy character is determined (ST32). If the determination at ST32 is YES, automatic processing is performed in accordance with the gaming program so that the enemy character makes an attack on the main character (ST33), and the WP of the enemy character is restored to the initial value (ST36). On the other hand, if it is determined at ST32 that the character for which command selection is made effective is the main character, subsequently “command acceptance processing” of accepting command selection of the player is performed (ST34). The “command acceptance processing” is described later in detail.

Next, the command selection of the player accepted in the “command acceptance processing” is checked and “command processing” for executing display processing responsive to the command type is performed (ST35). As the “command processing” is performed, display processing conforming to the action of the selected main character is executed. For example, when an attack command (FIGHT command described later) is selected, display processing such that an attack is made on the enemy character is executed. When a command using a special skill (SPECIAL command described later) is selected, display processing such that a spell attack is made on the enemy character or that recovery spell is used for the attacked ally for recovery is executed. In the “command processing,” “judgment processing” for making possible technical intervention according to the operation timing of the player is also performed. The “command processing” is described later in detail.

After execution of the “command processing,” WP of the character for which command selection is made effective in the “WP decrement processing” is restored to the initial value (255) (ST36). Subsequently, whether or not the “battle processing” termination condition is satisfied is determined (ST37). When the determination at ST37 is NO, the process returns to ST30; when the determination is YES, “soul point addition processing” is executed (ST38). The “soul point addition processing” is described later in detail. The “battle processing” exit condition is any of the fact that the enemy characters appearing on the battle screen suffer a crushing defeat, the fact that the player selects an “ESCAPE” command and the main character party succeeds in escaping from the enemy characters, the fact that the main character party suffers a crushing defeat, or the fact that such an event for terminating the battle occurs.

After the “soul point addition processing” is executed, whether or not the battle is won is determined (ST39). When the determination at ST39 is NO, the “battle processing” is exited; when the determination is YES, processing of storing data in a monster picture book is performed (ST40). In the processing of storing data in the monster picture book, the parameter belonging to the beaten monster is stored in picture book data in the RAM 23. Then, the “battle processing” is exited.

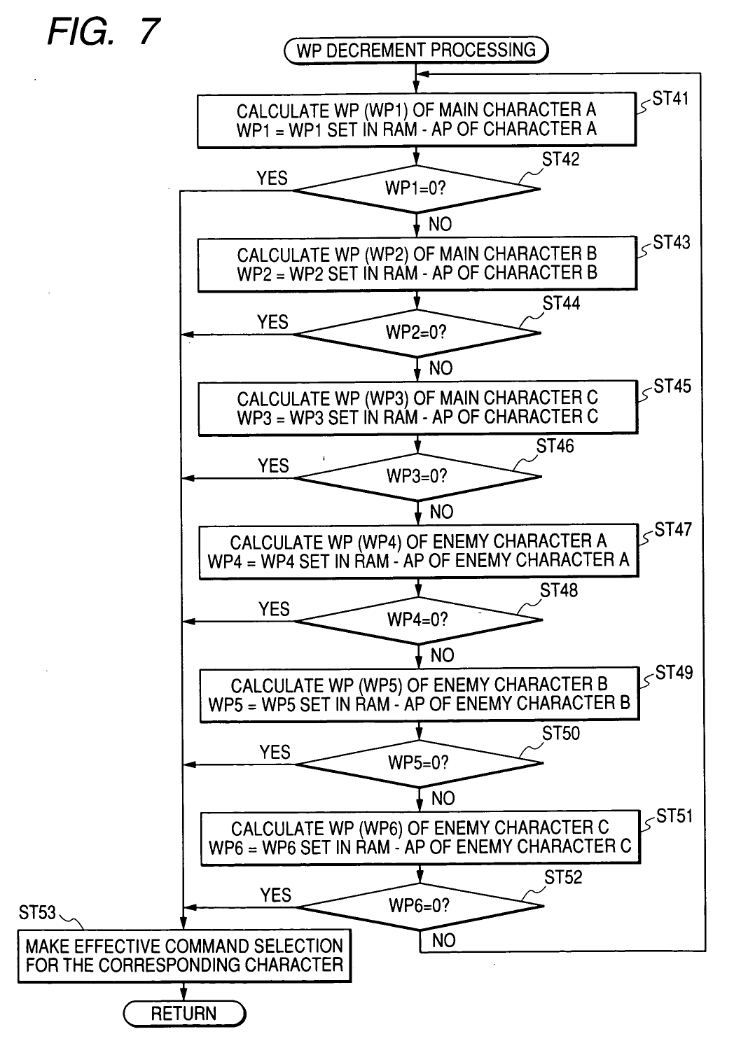

FIG. 7 shows a procedure of the “WP decrement processing” at ST32 in the “battle processing.” First, WP of the main character A 111 (WP of the main character A 111 is represented as WP1) is calculated and is set in a predetermined area of the RAM 23 (ST41). The initial value of WP is set to 255 and WP1 is calculated by subtracting skill value AP set for the main character A 111 from the value of WP1 set in the RAM 23 in the previous “WP decrement processing.” The WP calculation method is also applied to other characters in a similar manner and the skill value AP varies from one character to another. For each character, various character individual skills are preset in response to the character level (LV) determined by the experience value, and the skill value AP is calculated based on the status (described later).

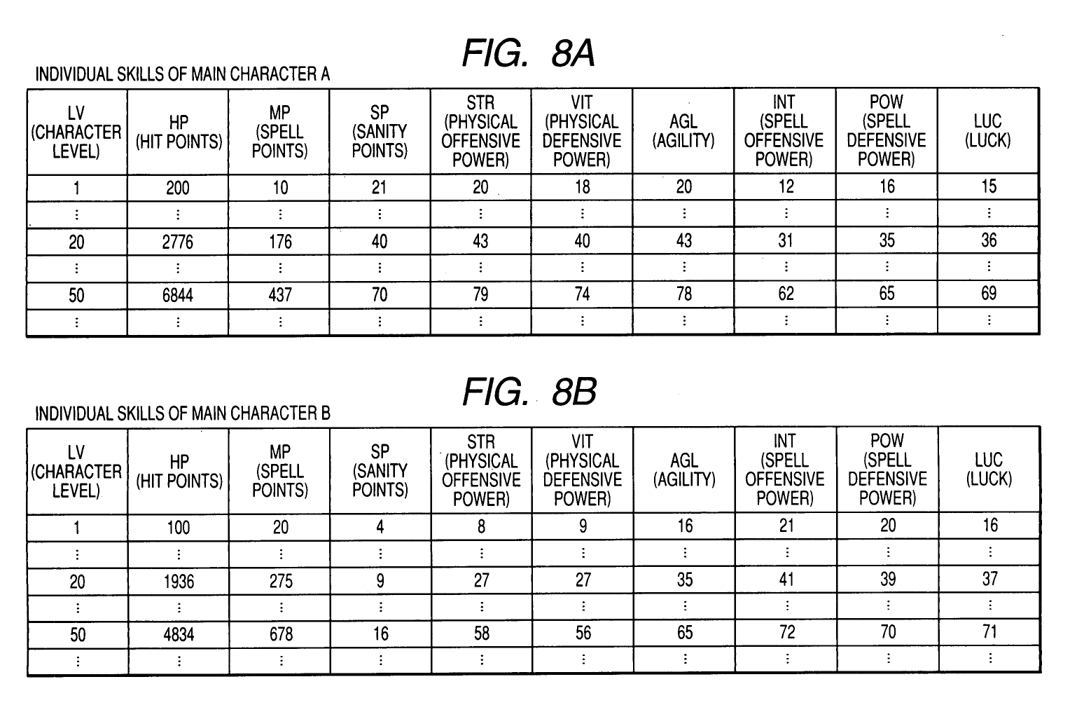

FIGS. 8A and 8B respectively show the character individual skills of the main characters A 111 and B 112 by way of example. As shown in FIG. 8, for each character, various character individual skills are preset in response to the character level (LV) varying depending on the experience value. The types of character individual skills include physical attack power (STR), physical defence power (VIT), agility (AGL), spell attack power (INT), spell defence power (POW), and luck (LUC) in addition to HP, MP, and SP described above. Each of them is represented by a numeric value and a different value is set depending on the type of character although the character level is the same. AP is calculated based on AGL and LUC. Specifically, AP=AGL+LUC/2.

After WP1 of the main character A 111 is thus found, subsequently whether or not found WP1 is 0 is determined (ST42). When the determination at ST42 is YES, command selection for the main character A 111 is made effective (ST53). Therefore, the player can make command specification for commanding the main character A 111 to take action of an attack, etc.

When the determination at ST42 is NO, WP of the main character B 112 (WP of the main character B 112 is represented as WP2) is calculated and is set in a predetermined area of the RAM 23 (ST43). Subsequently, whether or not found WP2 is 0 is determined (ST44). When the determination at ST44 is YES, command selection for the main character B 112 is made effective (ST53). When the determination at ST44 is NO, the process goes to ST45.

At ST45, WP of the main character C 113 (WP of the main character C 113 is represented as WP3) is calculated and is set in a predetermined area of the RAM 23. Subsequently, whether or not found WP3 is 0 is determined (ST46). When the determination at ST46 is YES, command selection for the main character C 113 is made effective (ST53). When the determination at ST46 is NO, the process goes to ST47.

At ST47, WP of the enemy character A 114 (WP of the enemy character A 114 is represented as WP4) is calculated and is set in a predetermined area of the RAM 23. Subsequently, whether or not found WP4 is 0 is determined (ST48). When the determination at ST48 is YES, command selection for the enemy character A 114 is made effective (ST53). When the determination at ST48 is NO, the process goes to ST49.

At ST49, WP of the enemy character B 115 (WP of the enemy character B 115 is represented as WP5) is calculated and is set in a predetermined area of the RAM 23. Subsequently, whether or not found WP5 is 0 is determined (ST50). When the determination at ST50 is YES, command selection for the enemy character B 115 is made effective (ST53). When the determination at ST50 is NO, the process goes to ST51.

At ST51, WP of the enemy character C 116 (WP of the enemy character C 116 is represented as WP6) is calculated and is set in a predetermined area of the RAM 23. Subsequently, whether or not found WP6 is 0 is determined (ST52). When the determination at ST52 is YES, command selection for the enemy character C 116 is made effective (ST53), and then the “WP decrement processing” is exited. On the other hand, when the determination at ST52 is NO, the process returns to ST41 and the “WP decrement processing” is again performed from the beginning.

Command Selection Screen

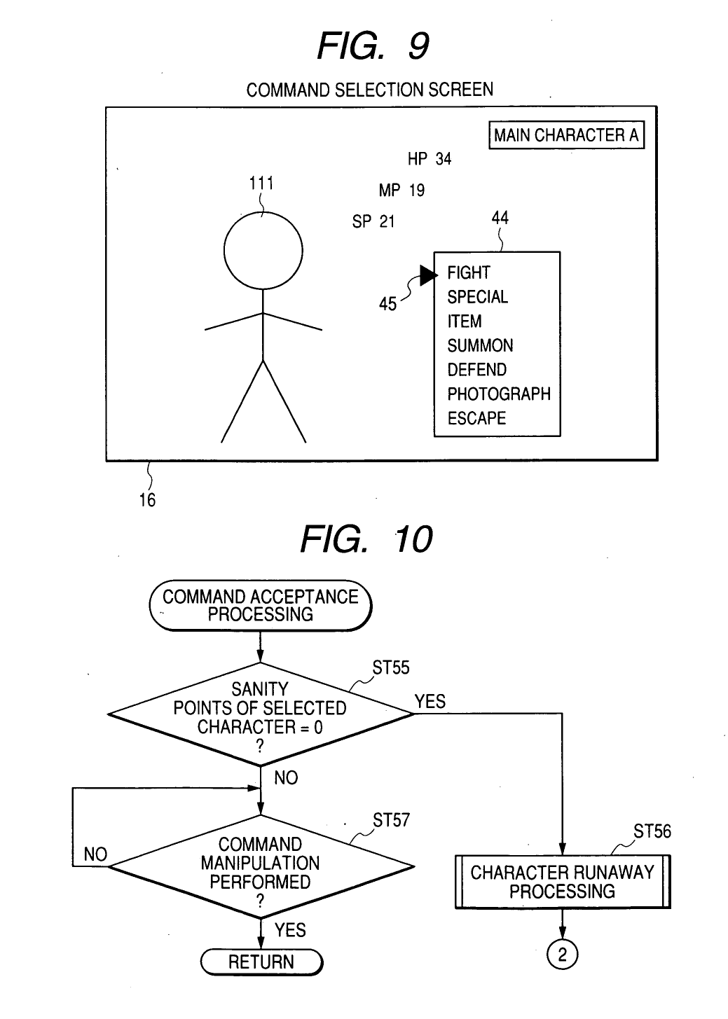

When the character for which command selection is made effective is the main character in the “WP decrement processing,” a selection mark 43 is displayed above the head of the main character for which command selection is made effective on the screen 16, as shown in FIG. 6. After the display, subsequently the main character with the selection mark 43 displayed above the head (in this case, the main character A 111) is zoomed up, and a “command selection screen” as shown in FIG. 9 is displayed.

The “command selection screen” shown in FIG. 9 displays a command menu 44 containing options of commands to determine the action of the main character A 111. When the player moves a cursor 45 displayed at the left of the command menu 44 by operating the up button 7 or the down button 8 and operates the O button 12, the command with the cursor 45 displayed at the left position is selected and the action of the main character A 111 is determined. In FIG. 9, five commands of FIGHT, SPECIAL, ITEM, SUMMON, DEFEND, PHOTOGRAPH and ESCAPE are displayed on the command menu 44. Here, the cursor 45 is displayed at the left position of the FIGHT command and the FIGHT command is selected. The values of HP, MP, and SP of the main character A 111 are displayed above the command menu 44.

Command Acceptance Processing

FIG. 10 shows a procedure of the “command acceptance processing” at ST35 in the “battle processing” (FIG. 5). First, when the character for which command selection is made effective in the “WP decrement processing” is the main character, whether or not SP of the main character is 0 is determined (ST55). If the determination at ST55 is YES, “character out-of-control processing” is performed for the main character (ST56) and the process goes to ST38 (FIG. 5). When the “character out-of-control processing” is executed, command manipulation for the main character becomes ineffective and the main character runs away so as to take abnormal action in such a manner that it makes an attack on any character regardless of whether the character is an enemy or an ally. On the other hand, when the determination at ST55 is NO, whether or not the player performs command manipulation, namely, manipulates a command on the “command selection screen” (FIG. 9) is determined (ST57).

Character out-of-control Processing

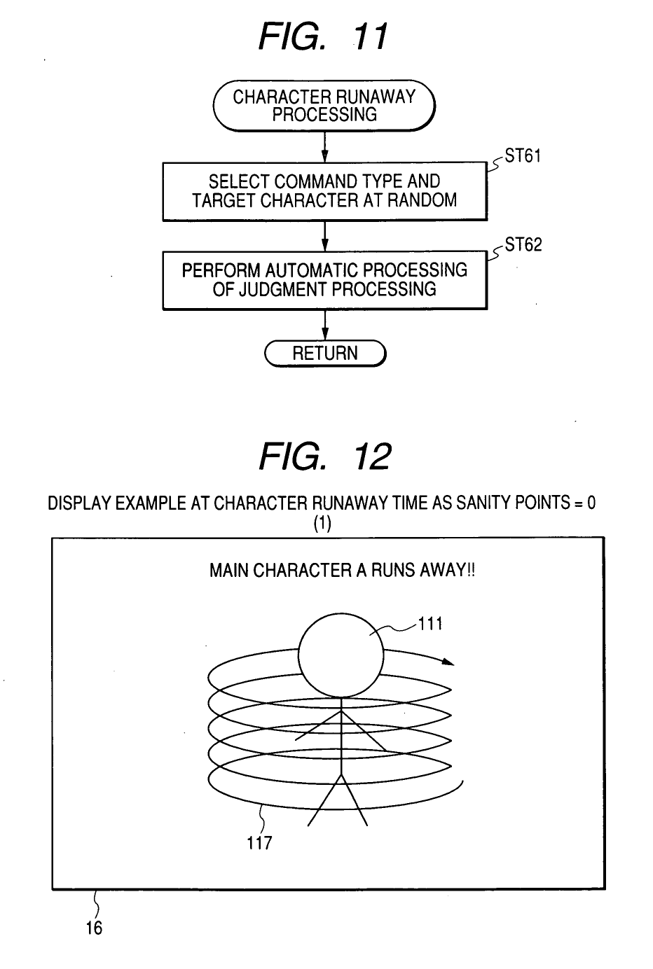

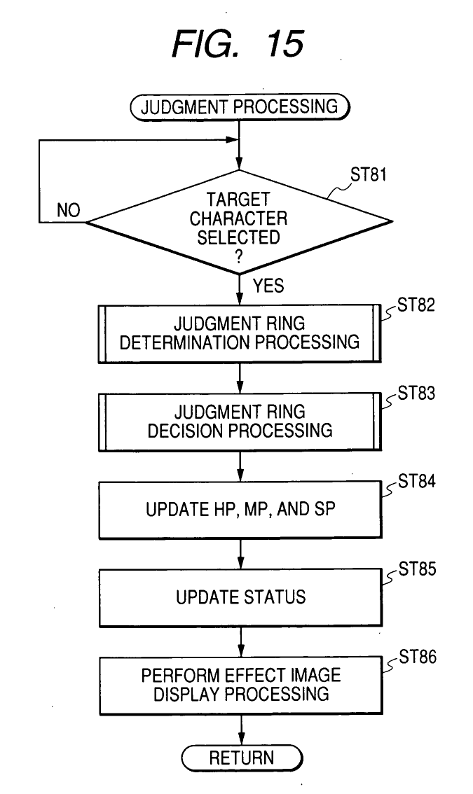

FIG. 11 shows a procedure of the “character out-of-control processing” at ST56 in the “command acceptance processing” (FIG. 10). First, the type of command for determining the action of the main character is selected at random and a character to which the action based on the command (attack, use of attack spell, use of recovery spell, etc.,) is applied is selected at random regardless of whether the character is an enemy or an ally (ST61). For example, when the FIGHT command is selected, a character to be attacked is selected at random regardless of whether the character is an enemy or an ally. Automatic processing of “judgment processing” described later for displaying the operation of the character determined based on the selected command, etc., is performed (ST62) and the “character out-of-control processing” (FIG. 15) is exited.

FIGS. 12 and 13 show specific. display examples when “character out-of-control processing” is executed; the figures show display examples when SP of the main character A 111 becomes 0 and the “character out-of-control processing” is executed for the main character A 111.

FIG. 12 shows the display mode just after execution of the “character out-of-control processing” is started, displaying how black smoke 117 rises from the legs of the main character A 111 and surrounds the body of the main character A 111. At this time, a character string of “main character A runs away!!” is also displayed on the screen 16. Then, a out-of-control mark 118 indicating that the main character A 111 runs away is displayed above the head of the main character A 111 and a character string of “heh, heh, heh . . . it's going to be fun . . . !” is also displayed, as shown in FIG. 13. Then, the main character A 111 takes action of an attack, etc., on the target character selected at ST61 (FIG. 11).

In the embodiment, once the out-of-control state is entered, no commands are accepted; however, only some commands may be accepted on a predetermined condition. For example, although only the ITEM command is accepted, which character the selected “item” is to be used for is unknown or one FIGHT command is accepted every three turns. The main character runs away when SP=0 and the character may be restored to the normal state after the expiration of a time interval rather than continuing to go out-of-control.

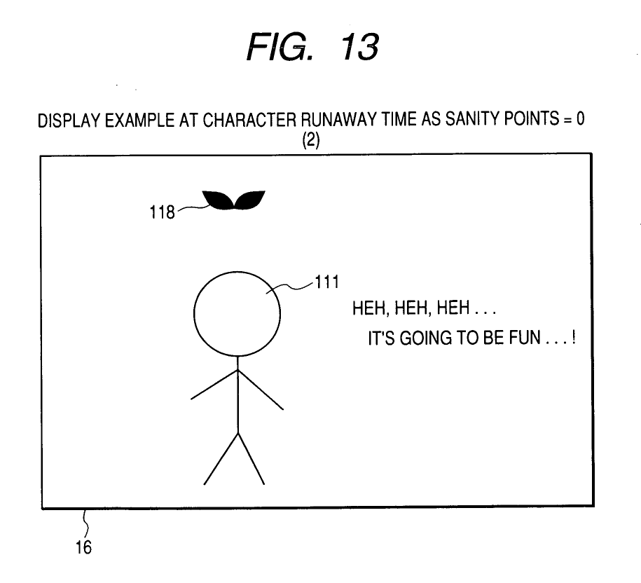

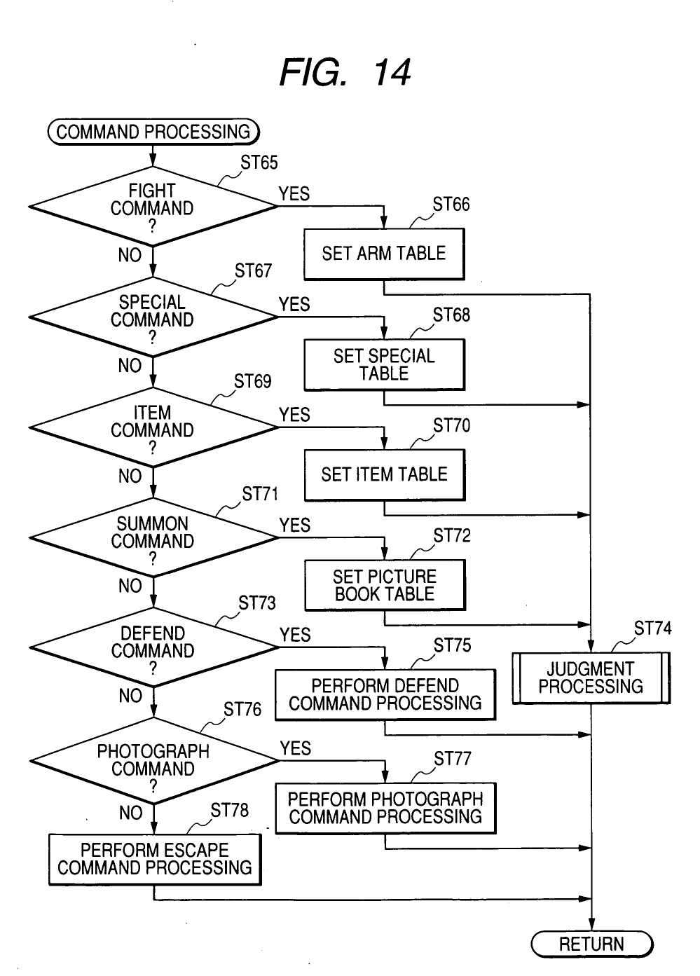

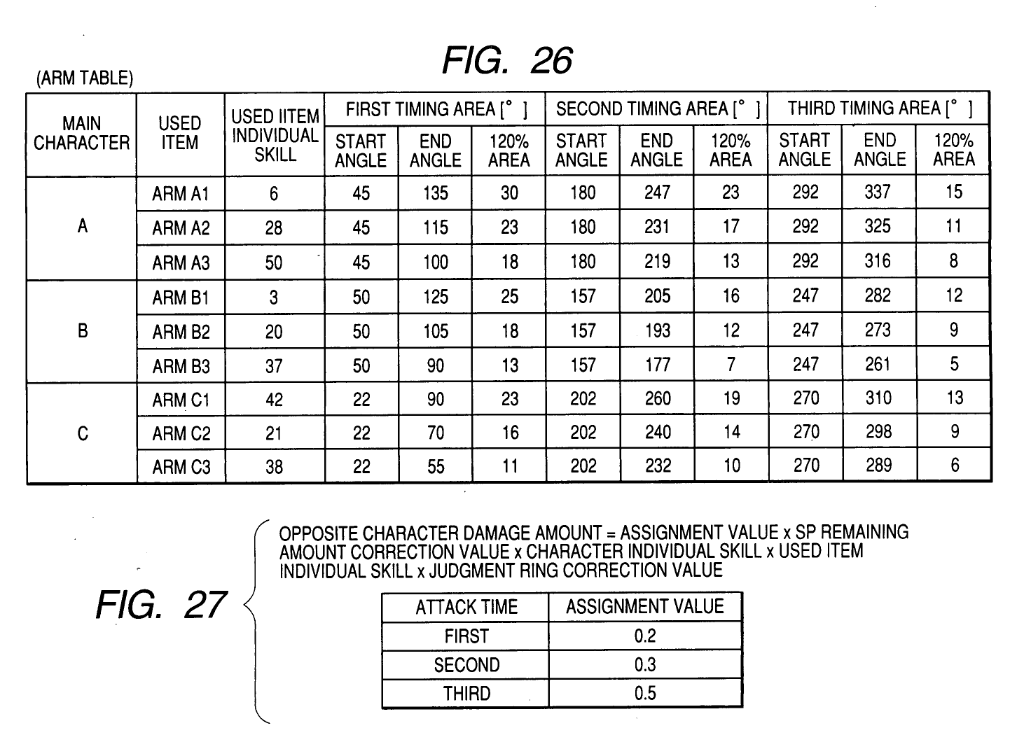

FIG. 14 shows a procedure of the “command processing” at ST37 in the “battle processing” (FIG. 5). First, whether the selected command is the FIGHT command is determined (ST65). When the determination at ST65 is YES, namely, when the player selects the option FIGHT on the “command selection screen” (FIG. 9), an “arm table” (shown in detail in FIG. 26) is fetched from the DVD-ROM 31 and is set in a predetermined area of the RAM 23 (ST66)

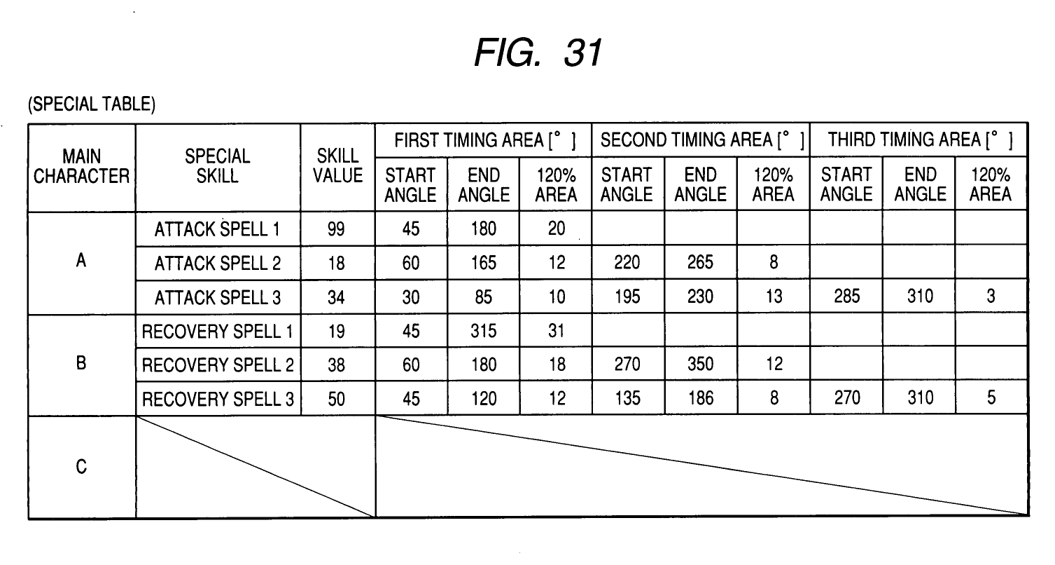

When the determination at ST65 is NO, whether the selected command is the SPECIAL command, namely, whether or not the player selects the option SPECIAL on the “command selection screen” (FIG. 9) is determined (ST67). When the determination at ST67 is YES, a “special table” (shown in detail in FIG. 31) is fetched from the DVD-ROM 31 and is set in a predetermined area of the RAM 23 (ST68).

When the determination at ST67 is NO, whether the selected command is the ITEM command, namely, whether or not the player selects the option ITEM on the “command selection screen” (FIG. 9) is determined (ST69). When the determination at ST69 is YES, an “item table” (shown in detail in FIG. 33) is fetched from the DVD-ROM 31 and is set in a predetermined area of the RAM 23 (ST70)

When the determination at ST69 is NO, whether the selected command is the SUMMON command, namely, whether or not the player selects the option SUMMON on the “command selection screen” (FIG. 9) is determined (ST71). When the determination at ST71 is YES, a “picture book table” (shown in detail in FIG. 25) stored in the RAM 23 is set in a predetermined area of the RAM 23.

When the determination at ST71 is NO, whether the selected command is the DEFEND command, namely, whether or not the player selects the option DEFEND on the “command selection screen” (FIG. 9) is determined (ST73). When the determination at ST73 is YES, DEFEND command processing for displaying how the main character defends from the attack of the enemy character is executed (ST75)

When the determination at ST73 is NO, whether the selected command is the PHOTOGRAPH command, namely, whether or not the player selects the option PHOTOGRAPH on the “command selection screen” (FIG. 9) is determined (ST76). When the determination at ST76 is YES, PHOTOGRAPH command processing for displaying how the main character takes a photograph of the enemy character is executed (ST77). The PHOTOGRAPH command is described later in detail.

When the determination at ST76 is NO, ESCAPE command processing for displaying how the main character escapes from the enemy character is executed (ST78).

When the player selects any of the FIGHT command, the SPECIAL command, the ITEM command, or the SUMMON command and the table corresponding to the selected command is set in the predetermined area of the RAM 23, “judgment processing” for displaying the operation of the main character determined based on the command and the table is executed (ST74), and then the command processing is exited.

Judgment Processing

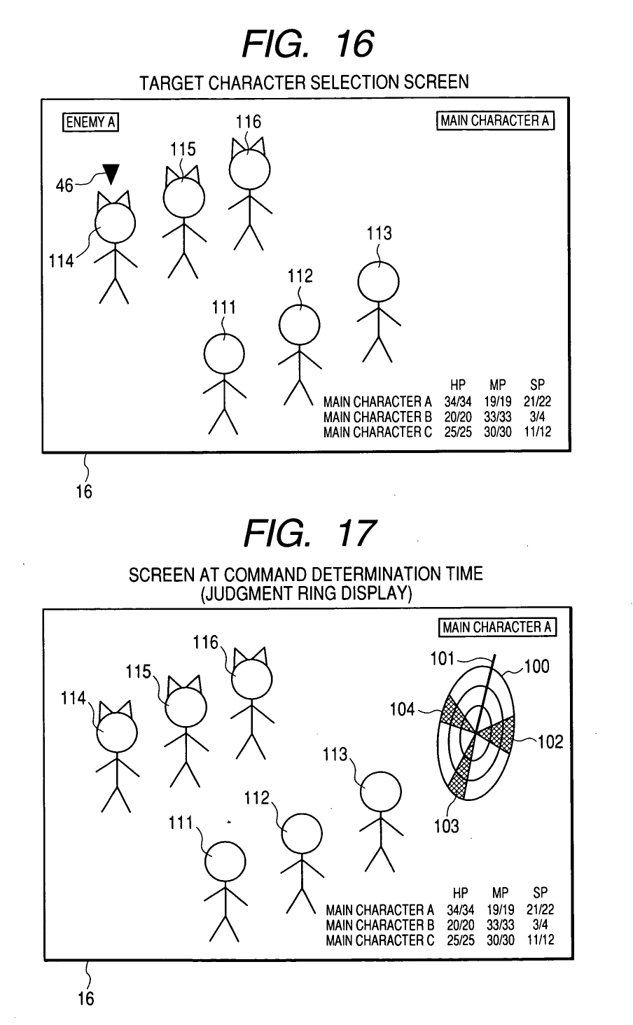

FIG. 15 shows a procedure of the “judgment processing.” First, whether or not the player selects a target character to which the action taken based on the selected command (attack, use of attack spell, use of recovery spell, etc.,) is applied is determined (ST81). Specifically, upon completion of command selection on the “command selection screen” (FIG. 9), a “target character selection screen” as shown in FIG. 16 is displayed and the player selects the target character on the screen. The target character is selected as follows: A selection mark 46 displayed on the “target character selection screen” is moved as the player operates the up button 7 or the down button 8. When the player operates the O buttton 12, the character with the selection mark 46 displayed above the head is determined to be the target character. FIG. 16 shows the case where the selection mark 46 is displayed above the head of the enemy character A 114 and the enemy character is determined to be the target character.

When the determination at ST81 is YES, “judgment ring determination processing” is executed (ST82) and subsequently “judgment ring decision processing” is executed (ST83).

Subsequently, the values of HP, MP, and SP are updated based on the damage amount or the recovery value calculated in the “judgment ring decision processing” at ST83 (ST84). Here, HP and MP are incremented or decremented and SP is decremented in response to the damage amount, the recovery value, etc. SP is decremented by one each time ST84 is executed. That is, it is decremented by one every turn of the character.

The SP decrement value may be determined in response to the damage amount, the recovery value, etc. For example, a value proportional to the damage amount, the recovery value, etc., (for example, the value of one-tenth of the damage amount, the recovery value, etc.,) is determined to be the SP decrement value.

The time interval between the instant at which command selection becomes effective and the instant at which the judgment ring 100 is displayed (the number of seconds) may be determined to be the SP decrement value. In this case, the time required for command selection of the player is set as the SP decrement value. Thus, when command selection of the player is rapid, the SP decrement value may be small, but it takes time in selecting a command, the value as much as the taken time is subtracted from the SP.

Next, the status of the character is updated in response to the determinations made at ST82 and ST83 (ST85). At ST85, if the status of the character is updated to the “abnormal status,” the character enters the abnormal status different from the usual status. The “abnormal status” varies depending on the type of attack item, spell, etc. For example, “poison” abnormal status is an abnormal status in which the physical strength of the character is automatically decreased every turn for the main character to take action upon reception of spell from the enemy or upon reception of attack of a predetermined item. “petrifaction” abnormal status is an abnormal status in which the character is fixed like a stone and it becomes impossible to enter a command upon reception of spell from the enemy or upon reception of attack of a predetermined item.

Effect image display processing for the main character to take predetermined action (attack, spell, etc.,) against the target character is executed based on the updated parameters (ST86), the “judgment processing” is exited.

In the game according to the invention, just before the main character takes action against the target character based on the selected command, a judgment ring 100 as a variable display area is displayed as shown in FIG. 17 and the necessary parameters for determining the effect are determined using the judgment ring 100.

As shown in FIG. 17, the judgment ring 100 is displayed in a state in which it is inclined in a slanting direction. Displayed on the judgment ring 100 is a rotation bar 101 as a varying area for clockwise rotating like a clock hand with the center point of the judgment ring 100 as a support. Also displayed on the judgment ring 100 are timing areas colored in predetermined angle ranges, which will be hereinafter referred to as timing areas. The timing areas are “effective areas” relatively advantageous to the player.

Then, the settings of the parameters are changed depending on whether or not the player can operate the O buttton 12 when rotation of the rotation bar 101 is started and the rotation bar 101 passes through any of the timing areas. The timing areas include three timing areas as shown in FIG. 17. The timing area through which the rotation bar 101 first passes is a “first timing area” 102, the timing area through which the rotation bar 101 next passes is a “second timing area” 103, and the timing area through which the rotation bar 101 last passes is a “third timing area” 104.

For example, when the player can well operate the O button 12 on any of the three timing areas, namely, the player can operate the O buttton 12 with the rotation bar 101 on any of the three timing areas, then the action taken by the main character against the enemy character becomes effective. When the FIGHT command is selected, three attacks are made on the enemy character to cause damage thereto by predetermined attack power. When the SPECIAL command is selected and recovery spell is used, spell having predetermined recovery power can be worked on an ally character three times for giving recovery power to the ally character.

In contrast, when the player upsets the operation timing of the O buttton 12 on one timing area, the advantage assigned to the timing area becomes ineffective. Particularly, when the player fails three times, the advantage becomes zero. In the embodiment, the player visually recognizes the effective areas of the judgment ring 100; the point is that the five senses of the player may be influenced to enable the player to recognize the operation timing. For example, it is also possible to adopt an auditory configuration wherein specific voice (sound) is generated for a predetermined time and the player is requested to operate in the generation section or a tactile configuration wherein the controller 4 or a portable terminal is vibrated and the player is requested to operate in the vibration generation section.

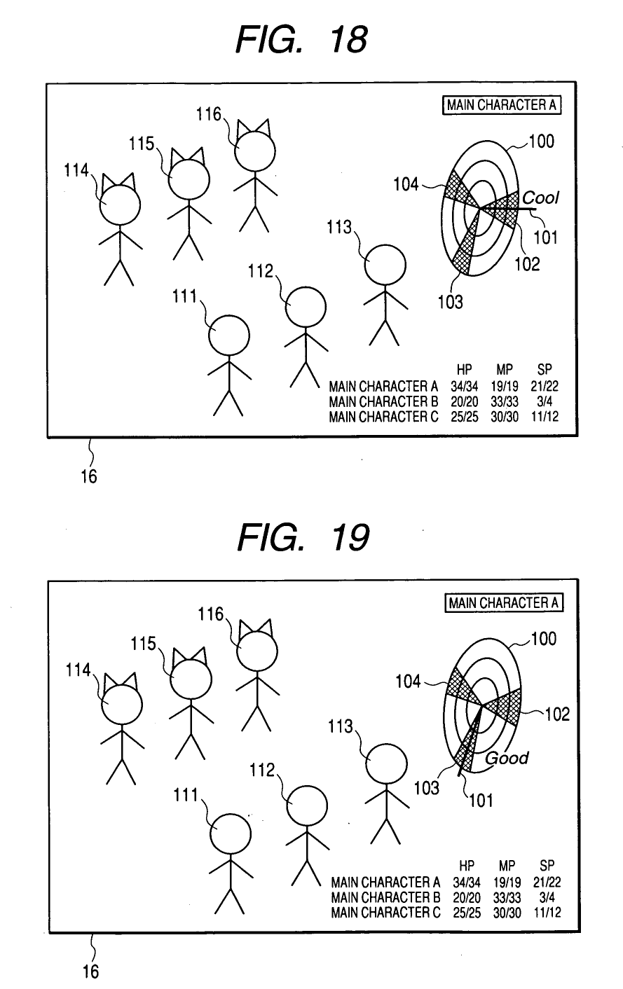

FIG. 18 shows a screen displayed when the O buttton 12 is operated when the rotation bar 101 passes through the first timing area 102. As shown in FIG. 18, when the player can well operate the O buttton 12 on the first timing area 102, a character string of COOL is displayed, for example.

FIG. 19 shows a screen displayed when the O buttton 12 is operated when the rotation bar 101 passes through the second timing area 103. As shown in FIG. 19, if the player can well operate the O buttton 12 on the second timing area 103, a character string of GOOD is displayed, for example.

FIG. 20 shows a screen displayed when the O buttton 12 is operated when the rotation bar 101 passes through the third timing area 104. As shown in FIG. 20, if the player can well operate the O buttton 12 on the third timing area 104, a character string of PERFECT is displayed, for example.

FIG. 21 shows a screen displayed when the O buttton 12 is operated before the rotation bar 101 enters the first timing area 102, namely, when the player fails in operating the O buttton 12 on the timing area. As shown in FIG. 21, if the player fails in operating the O button 12 on the timing area, a character string of MISS is displayed, for example.

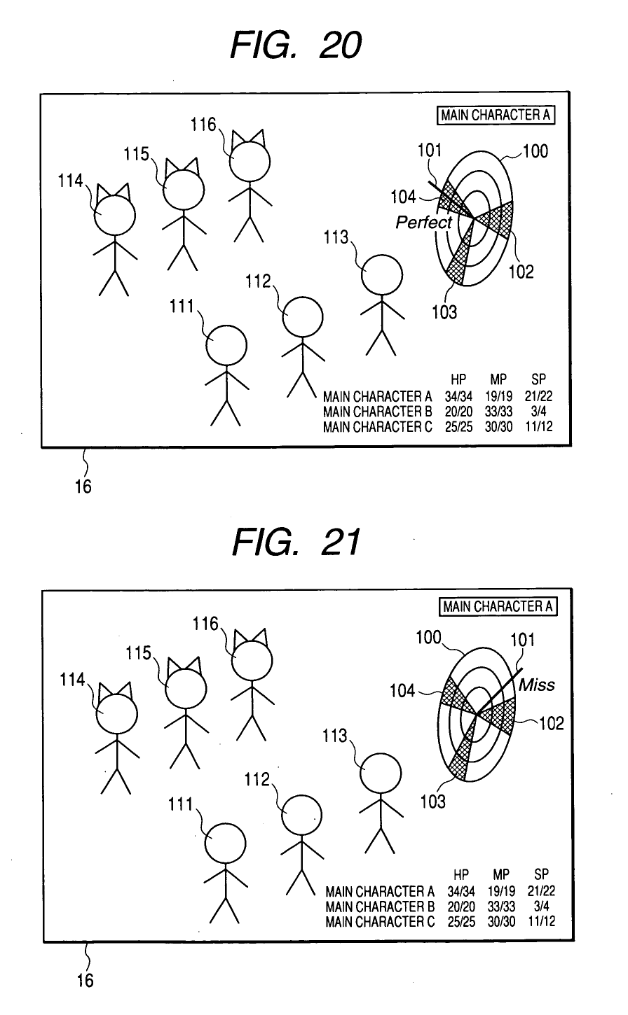

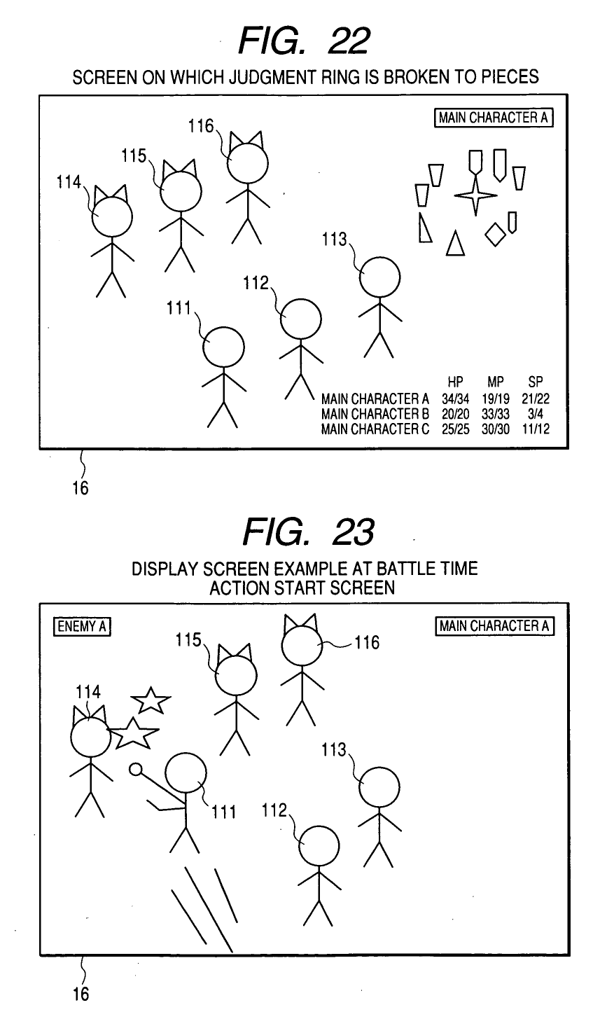

FIG. 22 shows a screen displayed after rotation of the rotation bar 101 stops when the player can well operate the O button 12 on the three timing areas, namely, when the player can operate the O button 12 when the rotation bar 101 exists on the three timing areas. As shown in FIG. 22, the judgment ring 100 is broken to pieces and the pieces scatter at the same time as rotation of the rotation bar 101 stops. Then, the main character A 111 with the FIGHT command selected in FIG. 9 moves to the enemy character A 114 selected as the target character in FIG. 16 and attacks the enemy character. The attack power at this time (damage amount to enemy character) varies depending on the operation timing of the O buttton 12 in the judgment ring 100.

FIG. 23 shows how the main character A 111 takes action against the enemy character A 114 based on the selected command and the operation result during display of the judgment ring 100. Here, the FIGHT command is selected and the main character A 111 attacks the enemy character A 114. When the player can well operate the O buttton 12 on the three timing areas during display of the judgment ring 100, the main character A 111 makes three attacks on the enemy character A 114 by predetermined attack power on the screen, as described above.

In the embodiment, if the player fails the first operation, he or she can give a challenge to the second operation, but when the player fails the first operation, operation acceptance may be terminated.

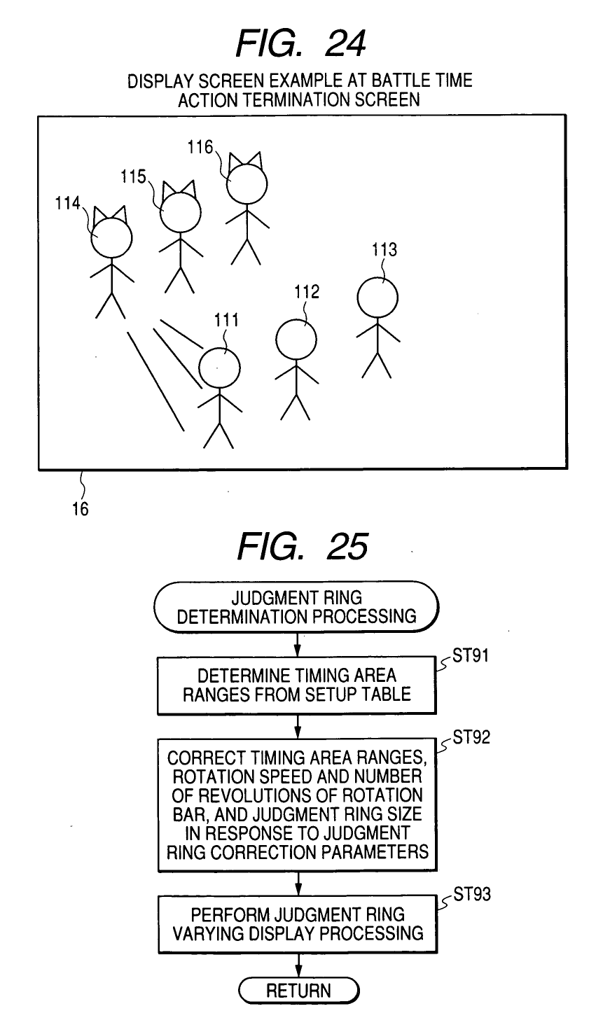

FIG. 24 shows a screen displayed when the main character A 111 terminates the attack on the enemy character A 114 and returns to the former position. Here, the time period from the start of action of the character or an enemy character against the target character (the state shown in FIG. 23) to the termination of the action (the state shown in FIG. 24) is referred to as “a (one) turn” and display processing for the one turn is performed in the “effect image display processing” at ST86 (FIG. 15).

Judgment Ring Determination Processing

FIG. 25 shows a procedure of the “judgment ring determination processing” at ST82 (FIG. 15). Here, first any of the “arm table” (FIG. 26), the “special table” (FIG. 31), or the “item table” (FIG. 33) set in the RAM 23 is referenced and the timing area ranges are determined (ST91). Subsequently, the timing area ranges determined at ST91, predetermined rotation speed and the predetermined number of revolutions of the rotation bar, and the size of the judgment ring are corrected based on judgment ring correction parameters described later (ST92). The rotation speed of the rotation bar is set to 1.5 seconds per round (revolution) as the basic speed, and the number of revolutions of the rotation bar is set to one as the basic number of revolutions. The judgment ring 100 is displayed in the timing area ranges finally determined at ST92 and rotation display of the rotation bar 101 is produced based on the determined rotation speed and the determined number of revolutions of the rotation bar 101 as judgment ring varying display processing (ST93). The timing areas and the judgment ring correction parameters are as follows:

FIG. 26 shows the “arm table.” The “arm table” is a table set when the player selects the FIGHT command. As shown in FIG. 26, the arms that can be used are defined according to the type of main character, and the used item individual skill and the range of each timing area are set in response to the type of arm.

The used item individual skill is used to calculate the damage amount to an enemy character (opposite character damage amount). The greater the numeric value of the used item individual skill, the larger the damage amount to the enemy character.

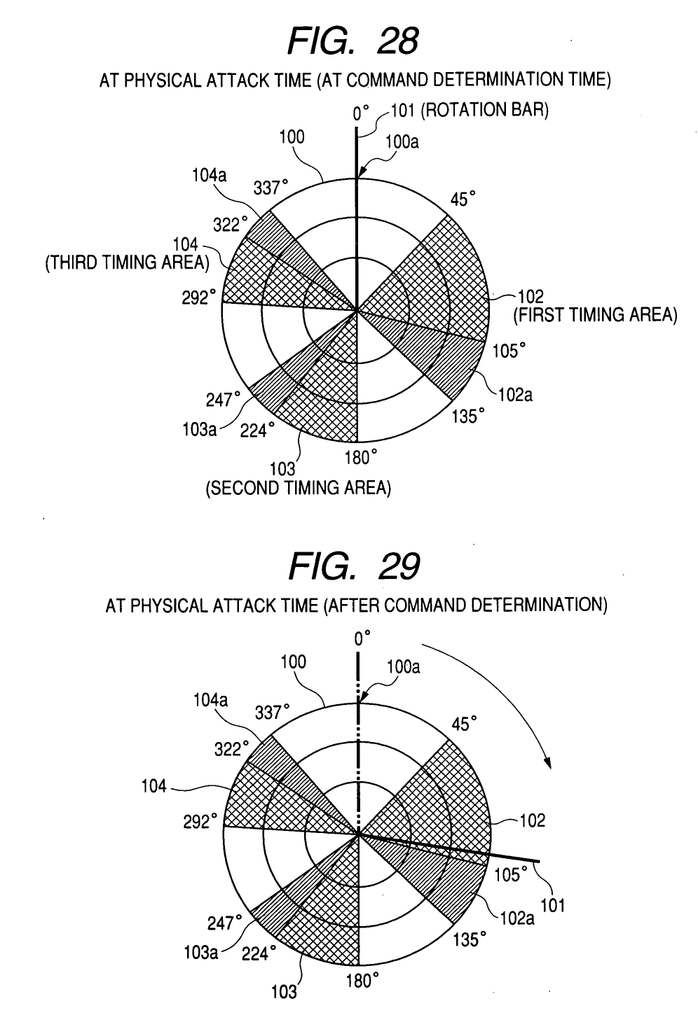

The range of each timing area is indicated by the angle range surrounded by the “start angle” and “end angle” with rotation start position of the rotation bar 101, 100a, as 0 degrees, as shown in FIG. 28. The “start angle” and “end angle” are set to different values in response to the type of used arm, as shown in FIG. 26. For example, when the main character is the main character A 111 and the used arm is an arm A1, the range of the first timing area 102 is set to the 90-degree angle range of the start angle 45 degrees to the end angle 135 degrees. The range of the second timing area 103 is set to the 67-degree angle range of the start angle 180 degrees to the end angle 247 degrees. The range of the third timing area 104 is set to the 45-degree angle range of the start angle 292 degrees to the end angle 337 degrees.

In the judgment ring 100, a “120% area” is set as a special effective area in the predetermined range of each timing area; when the rotation bar passes through the area, if the player can operate the O buttton 12, the damage amount to the enemy character increases 20%, namely, becomes 1.2 times. The “120% area” is formed in the range of the angle position resulting from subtracting the angle of the “120% area” from the end angle to the end angle.

FIG. 27 shows a calculation expression for calculating the damage amount to the enemy character (opposite character damage amount).

“Assignment value” is set to 0.2 at the first attack time, 0.3 at the second attack time, and 0.5 at the third attack time, as shown in FIG. 27.

“SP remaining amount correction value” is 1 until the current SP falls below 25% of the maximum SP, namely, while “25—current SP/maximum SP×100≦0” is satisfied. When the current SP falls below 25% of the maximum SP, namely, when “25—current SP/maximum SP×100>0” is satisfied, 0.01 is added to the “SP remaining amount correction value” and the “SP remaining amount correction value” becomes 1.01. Then, whenever SP is decremented by one, 0.01 is added to the “SP remaining amount correction value.” That is, whenever SP is decremented by one, the opposite character damage amount is increased 1%.

“Character individual skill” means the STR (physical attack power) shown in FIG. 8, and “used item individual skill” is a value set in response to the types of main character and arm shown in FIG. 28.

“Judgment ring correction value” is 1.2 if the player operates the O buttton 12 when the rotation bar 101 is on the 120% area of any timing area; 1 if the player operates the O buttton 12 when the rotation bar 101 is on any other area than the 120% area of any timing area; or 0 if the player does not operate the O buttton 12 when the rotation bar 101 is on any timing area.

For example, when the FIGHT command is selected, when the player can well operate the O buttton 12 on the three timing areas, namely, when the player can operate the O buttton 12 when the rotation bar 101 is on the three timing areas, then the main character repeats an attack on the enemy character three times to give predetermined damage to the enemy character. For example, when the main character A 111 uses the arm A1 to attack the enemy character, the opposite character damage amount at the first attack becomes “0.2×SP remaining amount correction value×STR×6×1 (1.2)” and as many points as the opposite character damage amount are subtracted from the HP of the enemy character. Likewise, the opposite character damage amount at the second attack becomes “0.3×SP remaining amount correction value×STR×6×1 (1.2)” and that at the third attack becomes “0.5×SP remaining amount correction value×STR×6×1 (1.2).” As many points as the opposite character damage amount are subtracted from the HP of the enemy character.

On the other hand, when the player upsets the operation timing of the O buttton 12 on one timing area, the later “judgment ring correction value” in the timing area becomes 0. For example, when the main character uses the arm A1 to attack the enemy character, when the player can operate the O buttton 12 when the rotation bar 101 is on the first timing area, the opposite character damage amount at the first attack becomes “0.2×SP remaining amount correction value×STR×6×1 (1.2).” However, when the player upsets the operation timing of the O buttton 12 on the second timing area, the “judgment ring correction value” at the second attack and that at the third attack become 0 and the opposite character damage amount also becomes 0.

When the HP of the enemy character becomes 0, it means that the main character beats the enemy character.

FIG. 28 shows the display mode of the judgment ring 100 displayed at the command determination time. It shows the judgment ring 100 displayed at the command determination time when the main character is the main character A 111, the arm A1 is used, and the FIGHT command is selected. The judgment ring 100 is formed according to the angle ranges of the timing areas set in the “arm table” shown in FIG. 26. When the main character is the main character A 111, the arm A1 is used, and the FIGHT command is selected, the start angle and the end angle of the first timing area 102 are 45 degrees and 135 degrees; those of the second timing area 103 are 180 degrees and 247 degrees; and those of the third timing area 104 are 292 degrees and 337 degrees. As shown in FIG. 28, the “120% area” in the first timing area 102 is a range 102a of 105 degrees resulting from subtracting 30 degrees from the end angle. 135 degrees to the end angle 135 degrees; the “120% area” in the second timing area 103 is a range 103a of 224 degrees resulting from subtracting 23 degrees from the end angle 247 degrees to the end angle 247 degrees; and the “120% area” in the third timing area 104 is a range 104a of 322 degrees resulting from subtracting 15 degrees from the end angle 337 degrees to the end angle 337 degrees.

FIG. 29 shows the display mode of the judgment ring 100 after the command determination. It shows a state in which the rotation bar 101 starts to rotate and passes through the first timing area 102.

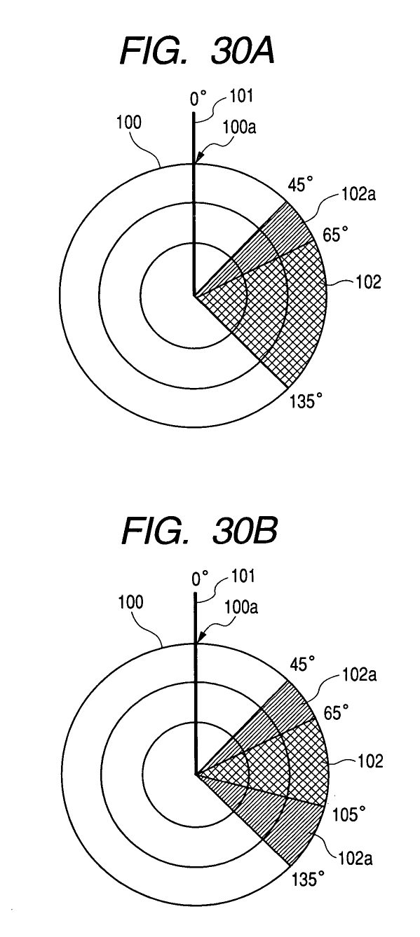

The “120% areas” are not limited to those described above. For example, the “120% area” may be provided in the range of the start angle to a predetermined angle as shown in FIG. 30A or two “120% areas” may be provided in one timing area as shown in FIG. 30B. FIG. 30A shows the case where the range 102a of the start angle 45 degrees to the angle 65 degrees (45 degrees+20 degrees) is set as the “120% area”. FIG. 30B shows the case where the range 102a of the start angle 45 degrees to the angle 65 degrees (45 degrees+20 degrees) and the range of the angle 105 degrees resulting from subtracting 30 degrees from the end angle 135 degrees to the end angle 135 degrees are set as the “120% areas”.

FIG. 31 shows the “special table.” The “special table” is a table set when the player selects the SPECIAL command. The SPECIAL command is a command using a special skill set for each character. For example, for the character A 111, the character is transformed into a fusion monster described later and it is made possible to use attack spell although attack spell cannot be used in the usual status. As shown in FIG. 31, the special skills that can be used are defined according to the type of main character, and the skill value and the range of each timing area are set for each special skill.

As shown in FIG. 31, when the main character is the main character A 111, attack spell 1 to attack spell 3 can be used as the special skills. The skill values set for them are used to calculate the opposite character damage amount to give damage to the enemy character using the attack spell 1 to the attack spell 3. In this case, the greater the skill value of the used special skill, the larger the damage amount to the enemy character, namely, the number of points to decrease the HP of the enemy character. It is made possible to use the attack spell 1 to the attack spell 3 when the character is transformed into a fusion monster described later.

On the other hand, when the main character is the main character B 112, recovery spell 1 to recovery spell 3 can be used as the special skills. The skill values set for them are used to calculate the recovery value to recover an ally character using the recovery spell 1 to the recovery spell 3. In this case, the greater the skill value of the used special skill, the larger the recovery value of the ally character, namely, the number of points to recover the decreased HP of the ally character receiving damage from the enemy character.

The range of each timing area is indicated by the angle range surrounded by the “start angle” and “end angle” with rotation start position of the rotation bar 101, 100a, as 0 degrees, as with the “arm table” (FIG. 26). The “start angle” and “end angle” are set to different values in response to the type of used special skill. In addition, in the “special table,” only the first timing area 102 is set or only the first timing area 102 and the second timing area 103 are set depending on the type of used special skill. The main character C 113 is not provided with such special skills and neither the skill value nor the timing area range is set in the “special table.”

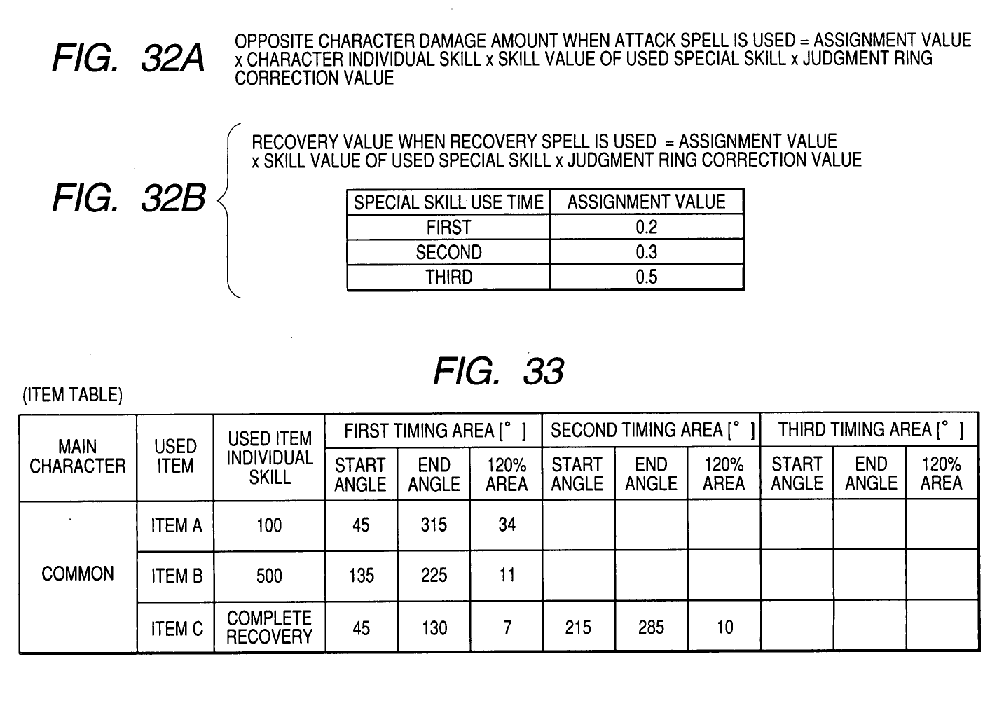

FIG. 32A shows a calculation expression for calculating the opposite character damage amount when each of the attack spell 1 to the attack spell 3 is used as the special skill and FIG. 32B shows a calculation expression for calculating the recovery value when each of the recovery spell 1 to the recovery spell 3 is used as the special skill.

“Assignment value” is set to 0.2 at the first special skill use time, 0.3 at the second special skill use time, and 0.5 at the third special skill use time, as shown in FIG. 32.

“Character individual skill” used with the calculation expression for calculating the opposite character damage amount when each of the attack spell 1 to the attack spell 3 in FIG. 32A means the INT (spell attack power) shown in FIG. 8. “Skill value of used special skill” is a skill value set in response to the types of main character and used special skill shown in FIG. 31.

“Judgment ring correction value” is 1.2 if the player operates the O buttton 12 when the rotation bar 101 is on the 120% area of any timing area; 1 if the player operates the O buttton 12 when the rotation bar 101 is on any other area than the 120% area of any timing area; or 0 if the player does not operate the O button 12 when the rotation bar 101 is on any timing area.

For example, when the SPECIAL command is selected for the main character A 111 and attack spell is selected as the used special skill, when the player can well operate the O buttton 12 on all displayed timing areas, then the main character A attacks the enemy character using the selected attack spell to give predetermined damage to the enemy character. For example, when the main character A uses the attack spell 1 to attack the enemy character, the main character A attacks the enemy character using the attack spell only once because only one timing area is set. The opposite character damage amount at this time becomes “0.2 ×INT×99×1 (1.2)” from FIG. 32A and as many points as the opposite character damage amount are subtracted from the HP of the enemy character.

When the SPECIAL command is selected and recovery spell is selected as the used special skill, when the player can well operate the O buttton 12 on all displayed timing areas, then the main character works the selected recovery spell on an ally character for recovery. For example, when the main character B uses the recovery spell 1, the main character B 112 uses the recovery spell on the ally character only once because only one timing area is set. The recovery value of the ally character at this time becomes “0.2×19×1 (1.2)” from FIG. 32B and as many points as the recovery value are added to the HP of the ally character.

Comparing the timing area ranges in the tables by character, in the “arm table” in FIG. 26, the timing area ranges set for the main character A 111 generally are wide as compared with those set for the main character B 112. For example, the sum total of the timing area ranges set for the main character A 111 using the arm A1 is the angle range of (135-45 degrees)+(247-180 degrees)+(337-292 degrees)=202 degrees, and the sum total of the timing area ranges set for the main character B 112 using the arm B1 is the angle range of (125-50 degrees)+(205-157 degrees)+(282-247 degrees)=185 degrees.

The reason why the difference exists is that the main character A 111 is a male character set to great physical strength and high physical attack power on the story and accordingly excels in an attack using an arm. Therefore, the timing area ranges when an arm is used, namely, when the arm table is selected are set wide, and the degree of difficulty in operating the judgment ring 100 is low.

On the other hand, in the “special table” in FIG. 31, the timing area ranges set for the main character B 112 are wider than those set for the main character A 111.

The reason why the difference exists is that the main character B 112 is a female character set to a sorcerer on the story; the timing area ranges when recovery spell is used, namely, when the special table is selected are set wide, and the degree of difficulty in operating the judgment ring 100 is low.

Thus, the features of the characters because of setting the story are involved in the execution condition of the judgment ring 100, so that not only the simple technical intervention element, but also the amusement of finding out commands matching the characteristics of the characters occur, and the interest in the game is furthermore increased.

FIG. 33 shows the “item table.” The “item table” is a table set when the player selects the ITEM command. The used item individual skill and the range of each timing area are set in response to the type of used item. As shown in the “item table,” items A to C can be used common to all main characters. Each of the items A to C is an item to recover the decreased HP of an ally character receiving damage from an enemy character. Therefore, the used item individual skill is used to calculate the recovery value to recover the ally character using each of the items A to C.

The calculation expression for calculating the recovery value when the main character uses each of the items A to C is the same as that in FIG. 32B, and “assignment value” is set to 0.2 at the first item use time and 0.3 at the second item use time.

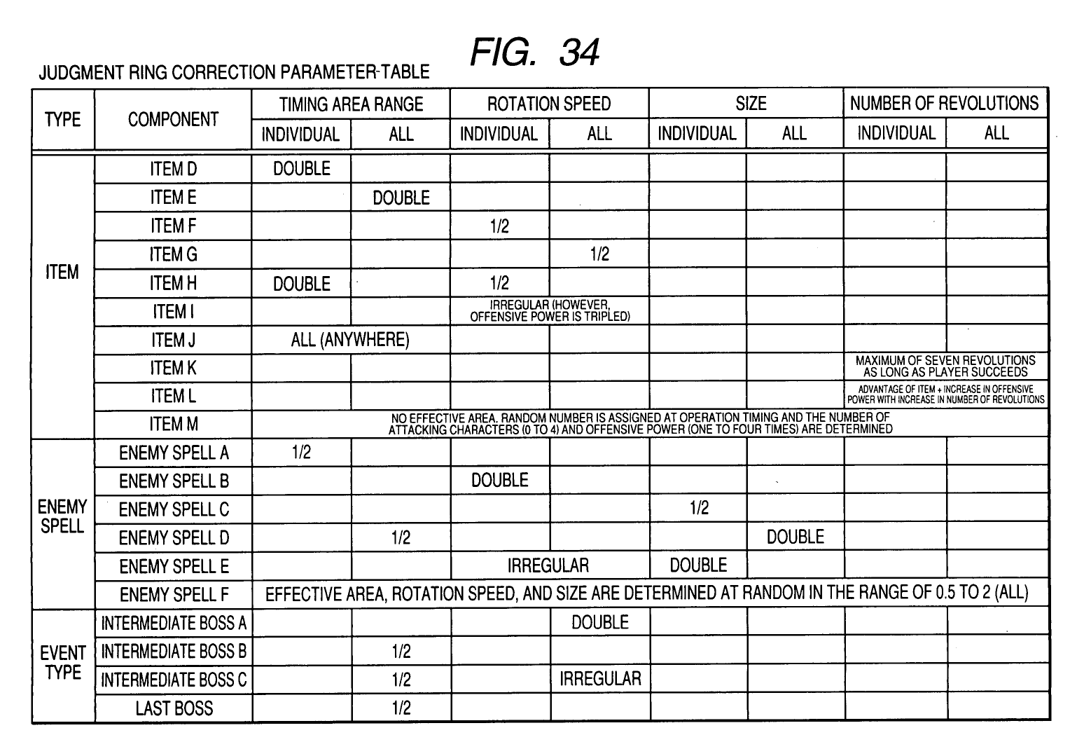

FIG. 34 shows a “judgment ring correction parameter table.” The “judgment ring correction parameter table” lists parameters for changing the display mode of the judgment ring 100 (ranges of timing areas, rotation speed and number of revolutions of rotation bar, and size of judgment ring), which will be hereinafter referred to as judgment ring correction parameters, and change in the display mode.

ITEM, ENEMY SPELL, and EVENT TYPE are included as the types of judgment ring correction parameters listed in the “judgment ring correction parameter table.”

As listed in the “judgment ring correction parameter table,” 10 types of items (item D to item M) are set in the judgment ring correction parameter ITEM, and it is made possible to obtain the items as the main character party clears a predetermined condition on each “sub-map.” To use the items at a battle scene, a store, etc., the display mode of the judgment ring 100 differs from the usual state and the judgment ring 100 is displayed in a very advantageous state to the player.

The advantages produced when the items are used are as follows:

(1) When the item D or the item E is used, the range of each timing area is widened twice. That is, the O buttton 12 becomes easy to operate.

(2) When the item F or the item G is used, the rotation speed of the rotation bar 101 is halved. That is, the O buttton 12 becomes easy to operate.

(3) When the item H is used, the range of each timing area is doubled and the rotation speed is halved.

(4) When the item I is used, the rotation speed of the rotation bar 101 changes irregularly as it is increased or decreased. However, if the player can well operate the O buttton 12, the attack power, namely, the opposite character damage amount is tripled as a very advantageous state.

(5) When the item J is used, the whole range on the judgment ring 100 becomes the timing area. That is, the player achieves success regardless of where the player operates the O buttton 12 on the judgment ring 100.

(6) When the item K is used, the number of revolutions of the rotation bar 101, which usually is one, becomes a maximum of seven. In this case, the player can operate the O buttton 12 with care.

(7) When the item L is used, the advantage of the item I works, the number of revolutions increases, and the opposite character damage amount increases in response to the consumption number of the number of revolutions when the player succeeds in operating the O buttton 12.

(8) When the item M is used, no timing areas are displayed on the judgment ring 100, but the number of main characters for attacking and the attack power are determined at random in response to the operation timing of the O buttton 12.

In blanks in the “judgment ring correction parameter table,” the same mode as at the usual time is applied.

As the player acquired the item D to the item M as the judgment ring correction parameters, it is made possible for the player to develop the game very advantageously and thus the items are set as rare items comparatively hard to acquire.

The ENEMY SPELL set as the judgment ring correction parameter means specific enemy spell of spell that the enemy character has (enemy spell). When the main character receives the enemy spell, the display mode of the judgment ring 100 becomes a disadvantageous state to the player. In the “judgment ring correction parameter table,” six types of enemy spell (enemy spell A to enemy spell F) are set in the judgment ring correction parameter ENEMY SPELL.

The disadvantages produced when the main character receives the enemy spell are as follows:

(1) When the main character receives the enemy spell A, the range of each timing area on the judgment ring 100 is halved.

(2) When the main character receives the enemy spell B, the rotation speed of the rotation bar 101 is doubled.

(3) When the main character receives the enemy spell C, the size of the judgment ring 100 is halved.

(4) When the main character receives the enemy spell D, the size of the judgment ring 100 is doubled, but the range of each timing area on the judgment ring 100 is halved.

(5) When the main character receives the enemy spell E, the size of the judgment ring 100 is doubled, but the rotation speed of the rotation bar 101 changes irregularly as it is increased or decreased. In this case, if the player can well operate the O button 12, the attack power remains the usual attack power although it is tripled with the item I.

(6) When the main character receives the enemy spell F, the range of each timing area, the rotation speed of the rotation bar 101, and the size of the judgment ring 100 are determined at random in the range of half to double.

The EVENT TYPE set as the judgment ring correction parameter is an event that the main character party fights a battle with a specific enemy character. When the event occurs, the display mode of the judgment ring 100 becomes a disadvantageous state to the player. In the “judgment ring correction parameter table,” four event types (intermediate bosses A to C and wrath boss) are set in the judgment ring correction parameter EVENT TYPE.

The advantages produced when the event types occur are as follows:

(1) The event type INTERMEDIATE BOSS A is an event that the main character party encounters INTERMEDIATE BOSS A, one type of enemy boss character, and fights a battle therewith. When the event occurs, the rotation speed of the rotation bar 101 is doubled.

(2) The event type INTERMEDIATE BOSS B is an event that the main character party encounters INTERMEDIATE BOSS B, one type of enemy boss character, and fights a battle therewith. When the event occurs, the range of each timing area is halved.

(3) The event type INTERMEDIATE BOSS C is an event that the main character party encounters INTERMEDIATE BOSS C, one type of enemy boss character, and fights a battle therewith. When the event occurs, the range of each timing area is halved and further the rotation speed of the rotation bar 101 changes irregularly as it is increased or decreased.

(4) The event type WRATH BOSS is an event that the main character party encounters WRATH BOSS, one type of enemy boss character, and fights a battle therewith. When the event occurs, the range of each timing area is halved.

The boss character is an enemy character for enabling the player to acquire a very large number of experience points as the player beats the boss character, as compared with the normal enemy character and therefore the display mode of the judgment ring 100 becomes a state in which the player is hard to operate the O buttton 12, as described above.

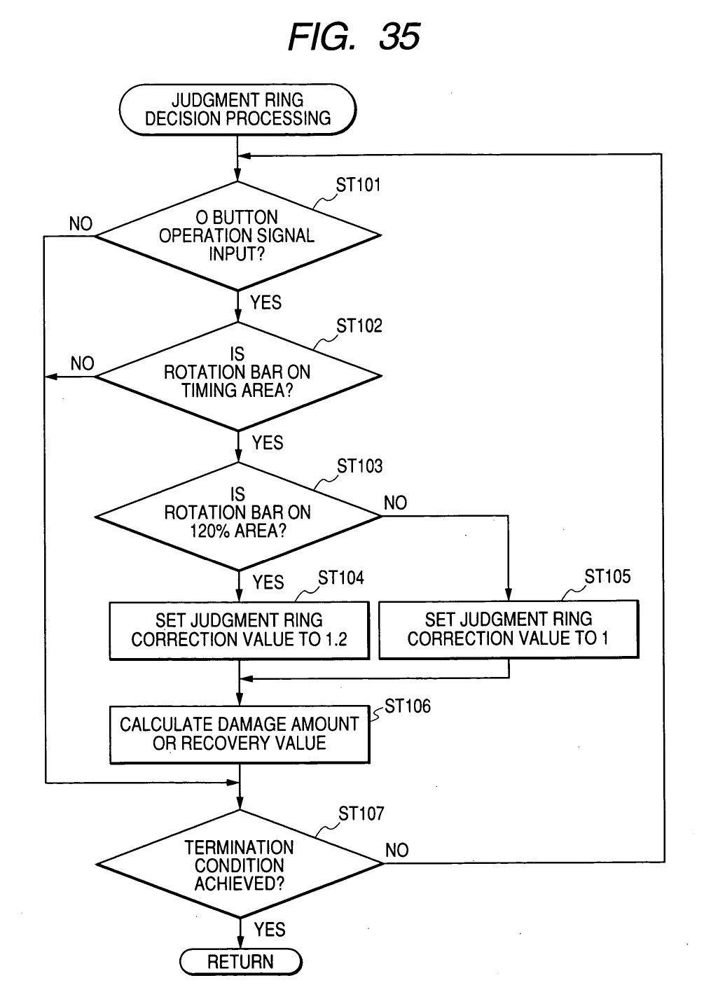

FIG. 35 shows a procedure of the “judgment ring decision processing” at ST83 in FIG. 15. This processing is processing after rotation of the rotation bar 101 in the judgment ring 100 is started in the “judgment ring determination processing.” First, whether or not the player operates the O buttton 12 and the operation signal is input is determined (ST101). When the determination at ST101 is NO, the process goes to ST107. When the determination is YES, namely, when it is determined that the operation signal is input, subsequently whether or not the rotation bar 101 is on any of the timing areas is determined (ST102).

When the determination at ST102 is NO, the process goes to ST107. When the determination is YES, namely, when the rotation bar 101 is on any of the timing areas, subsequently whether or not the position of the rotation bar 101 is on a 120% area is determined (ST103). The case where the determination at ST102 is NO is the case where the player cannot operate the O buttton 12 when the rotation bar 101 is on the timing area. In this case, the later operation of the O buttton 12 becomes ineffective, and the display termination conditions of the judgment ring 100 are achieved.

When the determination at ST103 is YES, namely, when the rotation bar 101 is on a 120% area, the judgment ring correction value 1.2 is set in a predetermined area of the RAM 23 (ST104). On the other hand, when the determination at ST103 is NO, namely, the rotation bar 101 is on the timing area other than a 120% area, the judgment ring correction value 1 is set in a predetermined area of the RAM 23 (ST105).

Subsequently, the opposite character damage amount or the recovery value is calculated according to the predetermined calculation expression based on the selected command, the type of main character, and the used item, and the calculation result is set in a predetermined area of the RAM 23 (ST106).

At ST107, whether or not the display termination conditions of the judgment ring 100 are achieved is determined. The termination conditions are (1) consumption of the specified number of revolutions (which is usually one; may increase in response to the judgment ring correction parameter) and (2) consumption of the specified number of observation push times (which is usually three; may change in response to various parameters). When the determination at ST107 is YES, the “judgment ring decision processing” is exited; when the determination is NO, the process returns to ST101.

Soul Point Addition Processing

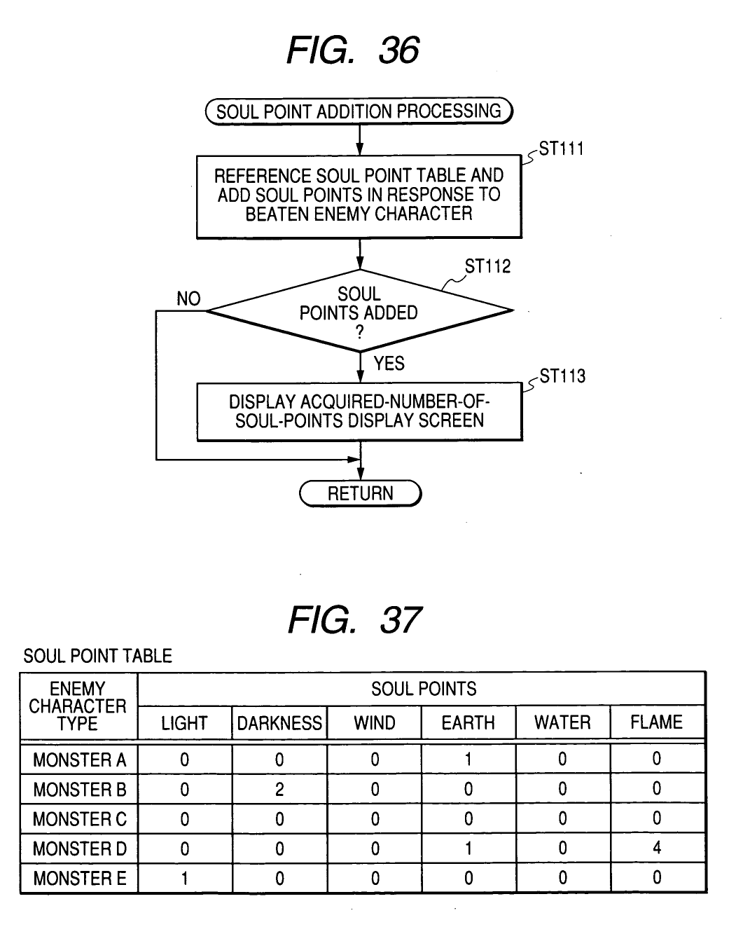

FIG. 36 shows a procedure of the “soul point addition processing” at ST39 (FIG. 5). This processing is performed after the above-mentioned “one turn” termination in a battle scene. Points called “soul points” may be set for the enemy character with which the main character fights a battle. When the soul points are set for the enemy character beaten by the main character, the main character can acquire the soul points.

FIG. 37 shows a “soul point table” listing the enemy characters and their soul points. As shown in FIG. 37, the soul points involve six attributes of “light,” “darkness,” “wind,” “earth,” “water,” and “fire.” The gotten soul points are added to a “soul point addition counter” provided in the RAM 23 for each attribute.

Therefore, in the “soul point addition processing,” first the “soul point table” is referenced and the soul points set for the beaten enemy character are added (ST111). When the beaten enemy character is a monster A, the soul points of the attribute “earth” are set to 1 and therefore 1 is added to the “soul point addition counter” for the attribute “earth.” When the beaten enemy character is a monster B, the soul points of the attribute “darkness” are set to 2 and therefore 2 is added to the “soul point addition counter” for the attribute “darkness.” When the beaten enemy character is a monster C, no soul points are set and therefore no soul points are added to the “soul point addition counter.” When the beaten enemy character is a monster D, the soul points of the attribute “earth” are set to 1 and the soul points of the attribute “fire” are set to 4 and therefore 1 is added to the “soul point addition counter” for the attribute “earth” and 4 is added to the “soul point addition counter” for the attribute “fire.” When the beaten enemy character is a monster E, the soul points of the attribute “light” are set to 1 and therefore 1 is added to the “soul point addition counter” for the attribute “light.”

Next, whether or not soul points are added is determined (ST112). When the determination at ST112 is NO, the “soul point addition processing” is exited; when the determination is YES, a “acquired-number-of-soul-points display screen” is displayed (ST113).

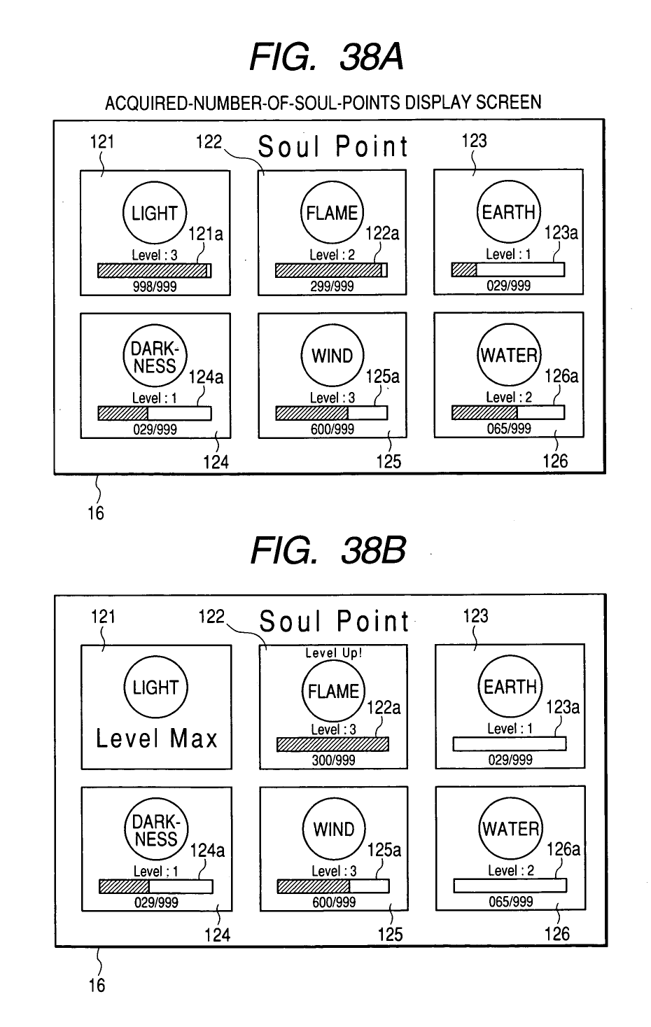

FIG. 38A shows a display example of the “acquired-number-of-soul-points display screen.” The acquired number of soul points of the attribute “light” is displayed as a level gage 121a and a numeric value in an area 121 in which a character string of LIGHT is displayed. The acquired number of soul points of the attribute “fire” is displayed as a level gage 122a and a numeric value in an area 122 in which a character string of FIRE is displayed. The acquired number of soul points of the attribute “earth” is displayed as a level gage 123a and a numeric value in an area 123 in which a character string of EARTH is displayed. The acquired number of soul points of the attribute “darkness” is displayed as a level gage 124a and a numeric value in an area 124 in which a character string of DARKNESS is displayed. The acquired number of soul points of the attribute “wind” is displayed as a level gage 125a and a numeric value in an area 125 in which a character string of WIND is displayed. The acquired number of soul points of the attribute “water” is displayed as a level gage 126a and a numeric value in an area 126 in which a character string of WATER is displayed.

The soul points are set so that the level is incremented by one in response to the acquired number of soul points. When the level is raised, the main character can fight a battle with a “fusion monster” described later. The “fusion monster” is an enemy character set so as to give a special skill to the main character provided that the main character beats the fusion monster. The special skill is a skill for enabling the main character to be transformed into the fusion monster.

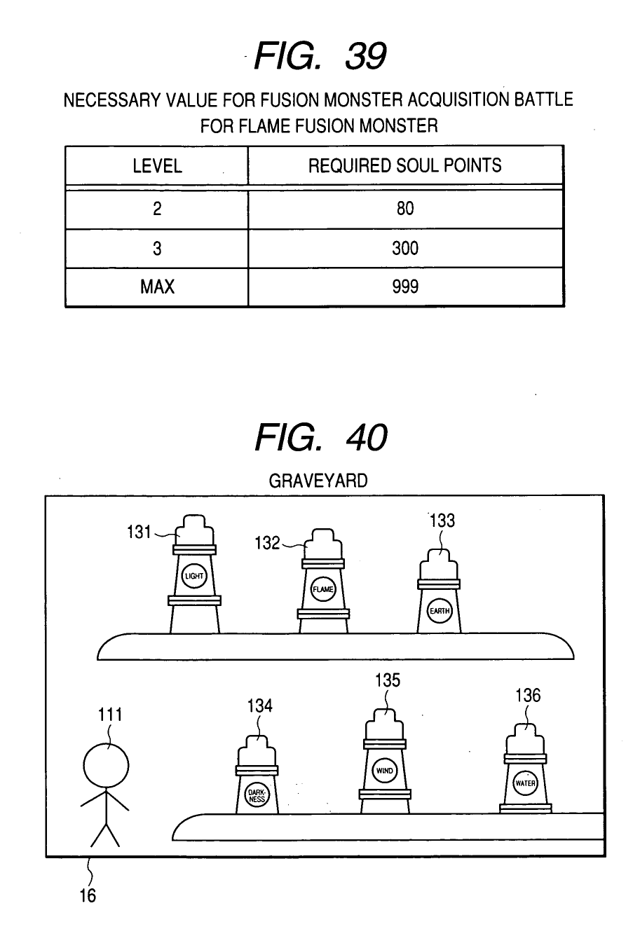

FIG. 39 shows an example of the number of soul points required for raising the level as a condition for fighting a battle with a fusion monster, which will be hereinafter referred to as the fusion level. Six types of fusion monsters (light fusion monster, fire fusion monster, earth fusion monster, darkness fusion monster, wind fusion monster, and water fusion monster) are set corresponding to the attributes of soul points.

In the example shown in FIG. 39, the number of soul points required for raising the fusion level as the condition for fighting a battle with the “fire fusion monster” is shown. In this case, when the acquired number of soul points reaches 80, the fusion level is raised to 2, enabling the main character to fight a battle with the “fire fusion monster” responsive to the level. When the acquired number of soul points reaches 300, the fusion level is raised to 3, enabling the main character to fight a battle with the “fire fusion monster” responsive to the level. Further, when the acquired number of soul points reaches 999, the fusion level becomes MAX, enabling the main character to fight a battle with the “fire fusion monster” responsive to the level. Thus, the fusion level is raised in response to the acquired number of soul points and as the fusion level is raised, the attack power of the fusion monster is also increased. When the main character beats the fusion monster, the main character obtains the skill of transforming itself into the beaten fusion monster.

Therefore, the numeric value displayed above each of the level gages 121a to 126a in FIG. 38A indicates the current fusion level. For example, “Level: 3” is displayed above the level gage 121a for displaying the acquired number of soul points of the attribute “light” and indicates that the fusion level is 3. The numeric value displayed below each of the level gages 121a to 126a means “current acquired number of soul points/maximum gotten number.” For example, “998/999” is displayed below the level gage 121a for displaying the acquired number of soul points of the attribute “light” and indicates that the current acquired number of soul points is 998 and the maximum number to be acquired is 999.

The indicator of each of the level gages 121a to 126a is set so as to reach the right end position when the soul points reach the predetermined number and the fusion level is raised. Therefore, when the fusion level is raised, then the indicator of each level gage 121a to 126a is cleared.

Another display example of the “acquired-number-of-soul-points display screen” shown in FIG. 38B indicates that a character string of “Level Max” is displayed in the area 121 in which the character string LIGHT is displayed, that the acquired number of soul points of the attribute “light” reaches the maximum gotten number 999, and that the fusion level as the condition for enabling the main character to fight a battle with the light fusion monster is raised to MAX. The “acquired-number-of-soul-points display screen” shown in FIG. 38 (2) indicates that a character string of “Level Up!” is displayed in the area 122 in which the character string FIRE is displayed, that the acquired number of soul points of the attribute “fire” reaches 300, and that the fusion level as the condition for enabling the main character to fight a battle with the fire fusion monster is raised to 3 from 2.

The player determines whether or not the main character is to fight a battle with the fusion monster by command selection. The command selection is effective only when the fusion level is raised. For example, when the character string “Level Up!” or “Level Max” as shown in FIG. 38B is displayed, the player can easily recognize the fusion level is raised, so that the player can fight a battle with the fusion monster by selecting a predetermined command in the next battle scene.

A battle with the fusion monster is fought in a “graveyard” different from a usual battle scene. When the fusion level is raised, a FUSION command is added to the command menu and when the player selects the FUSION command, the main character is guided into the “graveyard” and is enabled to fight a battle with the fusion monster.

FIG. 40 shows how the “graveyard” is displayed on the screen 16. Here, six gravestones 131 to 136 are displayed in a one-to-one correspondence with the six types of fusion monsters. The gravestone 131 with the character string LIGHT drawn thereon corresponds to the light fusion monster; the gravestone 132 with the character string FIRE drawn thereon corresponds to the fire fusion monster; the gravestone 133 with the character string EARTH drawn thereon corresponds to the earth fusion monster; the gravestone 134 with the character string DARKNESS drawn thereon corresponds to the darkness fusion monster; the gravestone 135 with the character string WIND drawn thereon corresponds to the wind fusion monster; and the gravestone 136 with the character string WATER drawn thereon corresponds to the water fusion monster.

When the player selects any gravestone, the fusion monster corresponding to the gravestone appears and the main character is enabled to fight a battle with the fusion monster.

In the display example in FIG. 40, the gravestones differ in height to indicate the fusion levels of the attributes. For example, the gravestone 131 corresponding to the light fusion monster indicates that the fusion level of the attribute “light” is MAX; the gravestone 132 corresponding to the fire fusion monster indicates that the fusion level of the attribute “fire” is 3; the gravestone 133 corresponding to the earth fusion monster indicates that the fusion level of the attribute “earth” is 1; the gravestone 134 corresponding to the darkness fusion monster indicates that the fusion level of the attribute “darkness” is 1; the gravestone 135 corresponding to the wind fusion monster indicates that the fusion level of the attribute “wind” is 3; and the gravestone 136 corresponding to the water fusion monster indicates that the fusion level of the attribute “water” is 2.

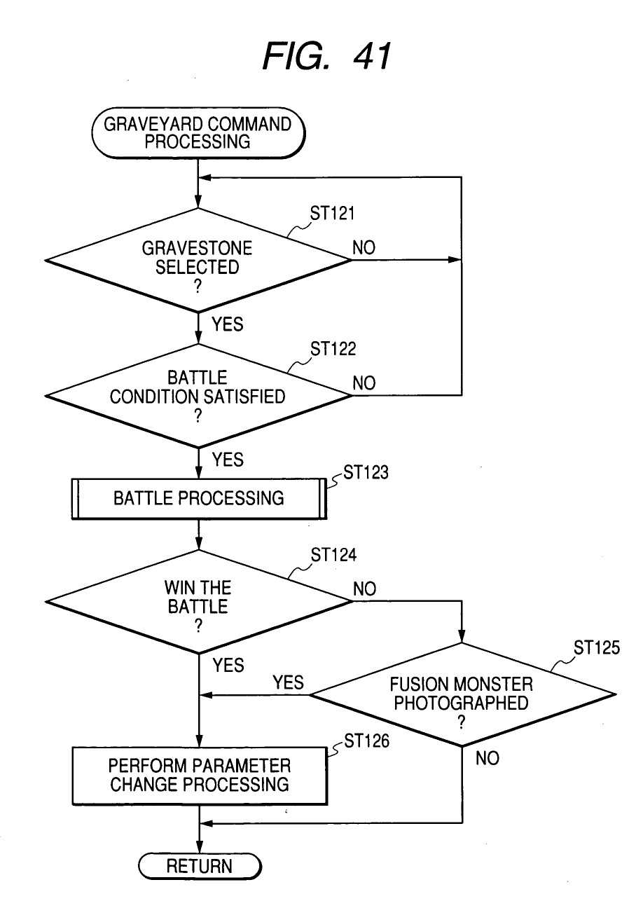

FIG. 41 shows a procedure of “GRAVEYARD command processing” performed when the player selects a GRAVEYARD command. First, whether or not the player selects any gravestone is determined (ST121). When the determination at ST121 is YES, whether or not the condition for fighting a battle with the fusion monster corresponding to the selected gravestone is satisfied (battle condition) is determined (ST122). The battle condition is either “that the fusion level of the attribute corresponding to the selected gravestone is just raised” or “that the fusion level is already raised and later a fight with the fusion monster is not fought.”

When the determination at ST122 is YES, the above-described “battle processing” for fighting a battle with the selected fusion monster is performed. In the “battle processing” (FIG. 5), the main character can use any arm in the “arm table” (FIG. 26) to attack the fusion monster. In addition, the main character can also “take a photograph of” the fusion monster. Once the main character can also “take a photograph of” the fusion monster, the main character can obtain the skill of transforming itself into the beaten fusion monster when the main character cannot beat the fusion monster as it escapes from the fusion monster or loses the battle later (FIG. 14).

In the “battle processing” (FIG. 5), when the main character beats the fusion monster and wins the battle (YES at ST124) or when the main character can take a photograph of the fusion monster (YES at ST125), “parameter change processing” is performed for adding the skill of transforming into the fusion monster (“fusion soul”) to the use items of the main character (ST126).

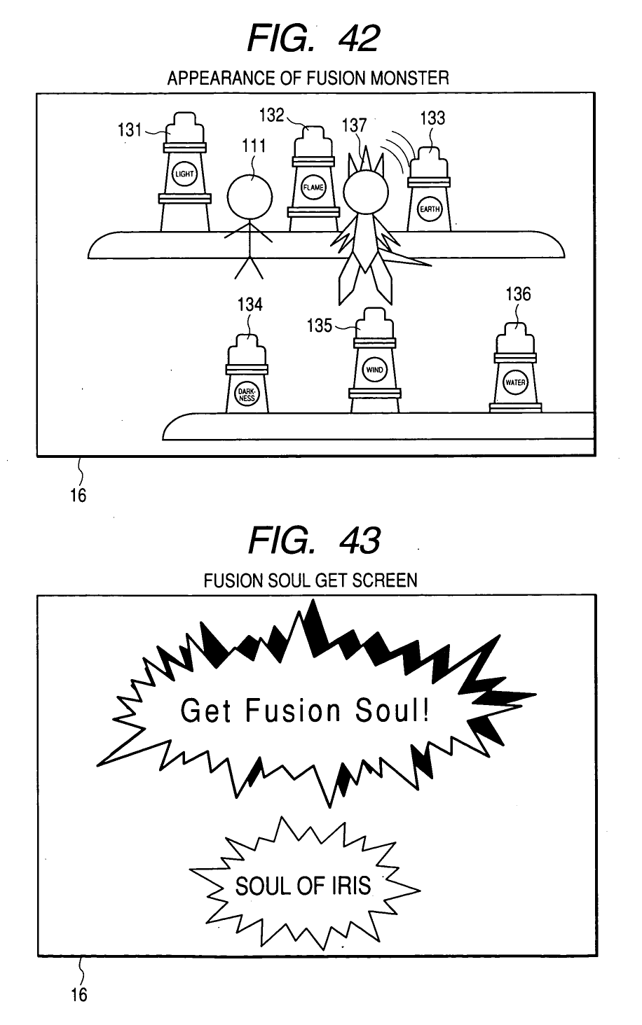

FIG. 42 shows how a fusion monster 137 corresponding to the selected gravestone appears from behind the gravestone.

FIG. 43 shows a “fusion soul get screen” displayed when the main character beats the fusion monster or takes a photograph of the fusion monster. Here, a character string of “Get Fusion Soul!” is displayed on the screen 16 and the name of the gotten fusion soul is displayed below the character string. In FIG. 43, SOUL OF IRIS is displayed as the name of the fusion soul. Here, IRIS is the name of the fusion monster.

Thus, when the main character acquires (gets) the fusion soul, it is made possible to make an attack using the fusion soul in the later battle scene. Specifically, the name of the gotten fusion soul (in this case, IRIS) is added to the command menu as a command in the battle scene after the fusion soul is gotten. As the command is selected, the main character can be transformed into the fusion monster.

As the main character is transformed into the fusion monster, not only its figure changes, but also it is made possible to use all skills of the fusion monster. That is, the main character becomes the fusion monster itself. A monster including the fusion monster, once beaten, is summoned by the main character selecting a SUMMON command in a battle, and attacks the opposite enemy character instead of the main character.

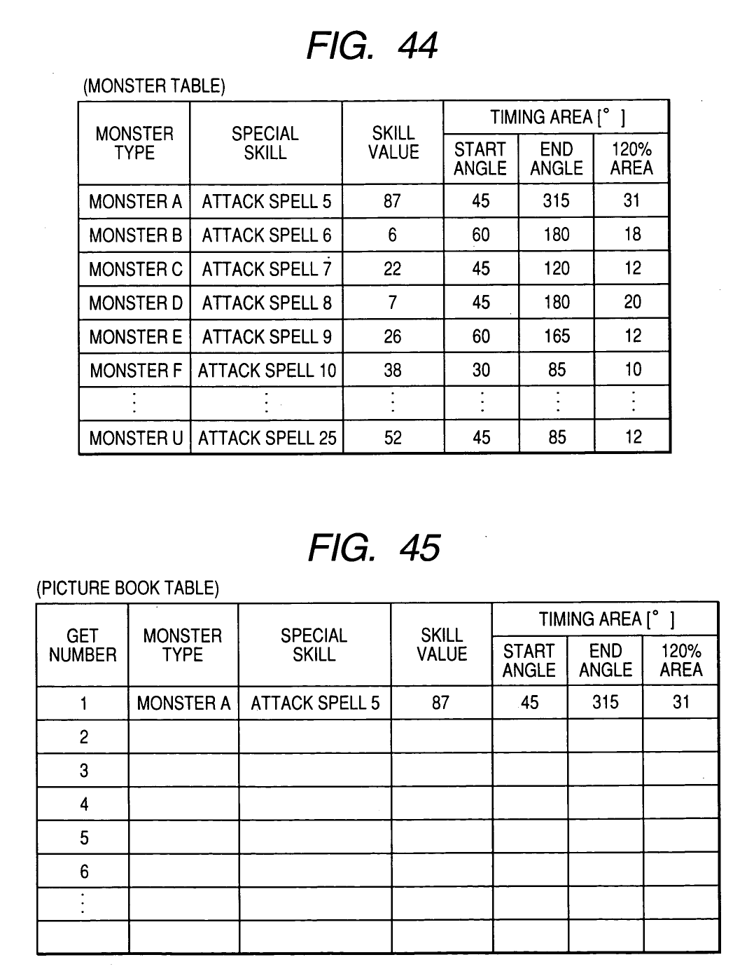

There are various types of monsters including the fusion monster, and different skills are assigned for each type of monster. FIG. 44 shows a monster table listing the data assigned for each type of monster. Initially the monster table is stored in the DVD-ROM 31 and the CPU 21 fetches the monster table and stores the monster table in a predetermined area of the RAM 23. In the monster table, the special skill, the skill value, and the parameters concerning the judgment ring when the monster is used by the main character after the monster is beaten by the main character are assigned for each type of monster. For example, in the monster table shown in FIG. 44, the monster A is assigned attack spell 5, the skill value 87 when monster is used by the main character, and the judgment ring with the start angle 45 degrees, the end angle 315 degrees, and 120% area 31 degrees.

Next, the PHOTOGRAPH command processing (ST77) executed when the player selects a PHOTOGRAPH command for the main character in a battle will be discussed. In the PHOTOGRAPH command processing, the data in the monster table corresponding to the type of monster, the enemy character to be photographed is copied into the picture book table. The PHOTOGRAPH command processing is the same processing as the processing of storing data in the monster picture book when the monster is beaten in the battle processing (ST40). FIG. 45 shows the picture book table. In the picture book table, the type of monster photographed by the PHOTOGRAPH command, the type of special skill, the skill value, and the parameters concerning the judgment ring are assigned. The parameters are copied from the columns of the monster table. The data in the monster table is also copied into the picture book table at ST40 when the main character beats the monster in the battle. The picture book table shown in FIG. 45 is an example wherein the parameters about the monster A read from the monster table are stored. When the data in the monster table is copied into the picture book table and becomes available, for example, a message of “it is made possible to summon monster A” may be displayed on the screen even during the battle, informing the player that it is possible to use by the SUMMON command.

Once the parameters of the monster are stored in the picture book table by the PHOTOGRAPH command, later it is made possible to continue to reference the parameters. Therefore, when the main character escapes from the battle (ST78) after taking a photograph, the parameters of the monster are not lost and can be referenced. Thus, the beginner player who is low at the operation skill level and is hard to beat the enemy would be able to use the PHOTOGRAPH command for the monster and later use the SUMMON command, thereby continuing the game using the highly effective technique given to the monster.

The monster stored in the picture book table can be displayed when the player enters a display request in menu display and processing (ST21 in FIG. 4).

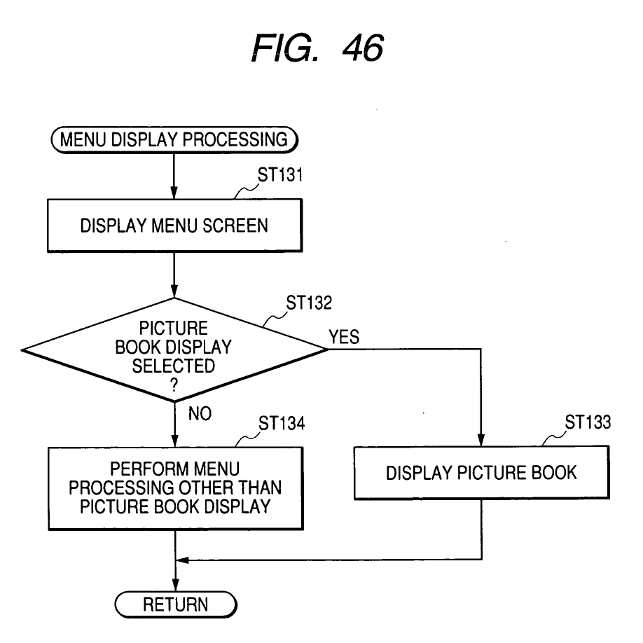

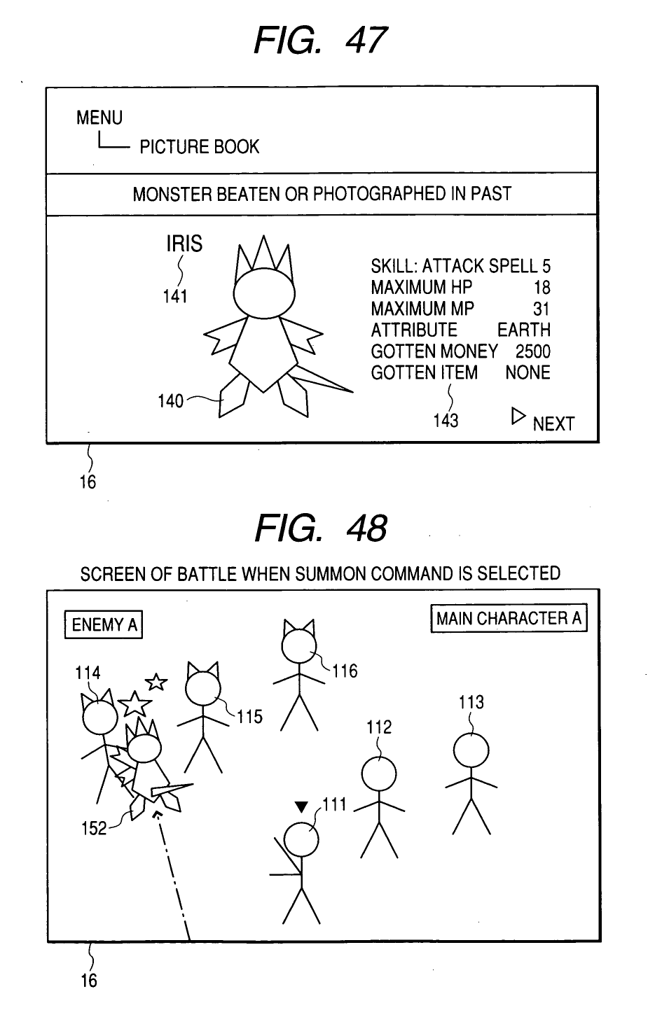

FIG. 46 shows “menu display processing” for displaying gotten monsters using a menu display screen. First, a menu screen is displayed (ST131), requesting the player to select desired information and setting. The options of the menu contain “picture book display” of a special menu in addition to a general menu. Subsequently, whether or not the player selects “picture book display” is determined (ST132). When the determination at ST132 is YES, a monster picture book describing the gotten monsters as beaten or photographed in the past battle scenes (ST133). FIG. 47 shows a display screen of the monster picture book. The screen displays a FIG. 140 of the monster A of the gotten fusion monster together with a character string of IRIS, the name of the monster, 141. The screen also displays a status 143 of the monster. The description of the status 143 of the monster includes the skill of the type of spell that can be used in action, the maximum HP, the maximum MP, the attribute, and the gotten money and gotten item that can be obtained when the monster is beaten. When the determination at ST132 is NO, general menu processing other than picture book display is performed (ST134). Then, the menu display processing is exited. Thus, the gotten monsters as photographed or beaten in the past are displayed in the monster picture book.

To make a battle, the main character can summon any monster displayed in the monster picture book and use the spell attack skill of the summoned monster to take action of attacking the enemy character. That is, when a main character D 150 is a selectable character in the command processing (FIG. 14), when the player selects a SUMMON command (YES at ST71 in FIG. 14), the parameter of the skill value of attack spell 5 belonging to the monster A stored in the picture book table is set in the RAM 23 (ST72). In the subsequent judgment processing (ST74), the damage amount to the enemy character against which the action is taken is calculated based on the parameter set in the RAM 23. Thus, action of the main character D 150 can be taken using the parameter of the monster A stored in the picture book table. When the player selects the SUMMON command, the monster is displayed on the screen in the effect display processing (ST86 in FIG. 15) and takes action against the enemy character. FIG. 48 shows a display example of the screen when the SUMMON command is selected. Here, the main character D 150 is a selectable character and instead of the main character D 150, a monster A 152 appears on the screen and takes action against the enemy character A 114. The summoned monster disappears after the action terminates. The monsters that can be summoned in the SUMMON command may be limited to some rather than all of the monsters with the parameters stored in the picture book table. For example, only the monsters having a utility value with the action skill higher than a given value can be summoned. This processing can be performed as the picture book table is set only when the skill value in the picture book table is greater than a predetermined value in the processing of setting the picture book table at ST72.

HP Display Processing

As described above, when a monster is gotten and its parameter is listed in the monster picture book, the monster is summoned and is used when the main character takes action. In this case, when the monster of the type gotten again appears as an opposite character, the information belonging to the monster can be displayed.

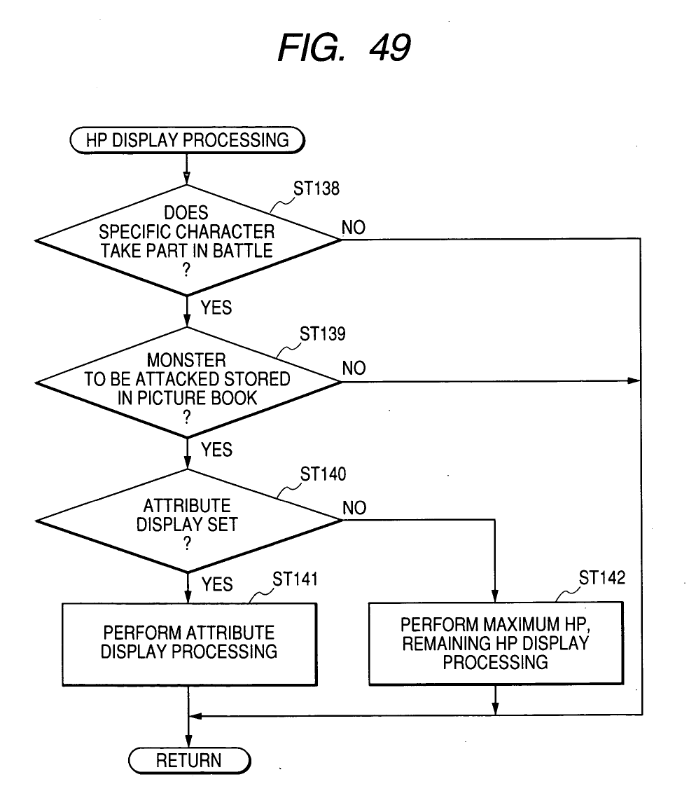

FIG. 49 shows HP display processing for displaying the HP information of the monster during the battle if the monster is listed in the picture book. In the HP display processing, first, whether or not a specific character takes part in the battle is determined (ST138). Some main characters are special characters having a skill of displaying information concerning the monster with which the main character fights a battle during the battle. For example, the main character D 150 (FIG. 47) is a character having the skill of displaying information concerning the monster with which the main character fights a battle, the information that usually cannot be known until action is determined. At ST138, whether or not the main character D 150 takes part in the battle is determined. When the main character D 150 takes part in the battle (YES at ST138), then whether or not the monster against which action is to be taken is stored in the picture book is determined (ST139). If it is determined that the monster is stored in the picture book (YES at ST139), then whether or not attribute display is set is determined (ST140) The attribute display is set as the technique for displaying the attribute of the enemy character is selected for the main character D 150. If the determination at ST140 is YES, attribute display processing (ST141) is preformed; when the determination is NO, maximum HP/remaining HP display processing (ST142) is performed. Thus, the HP is displayed as a bonus only when the main character D 150 takes part in the battle.

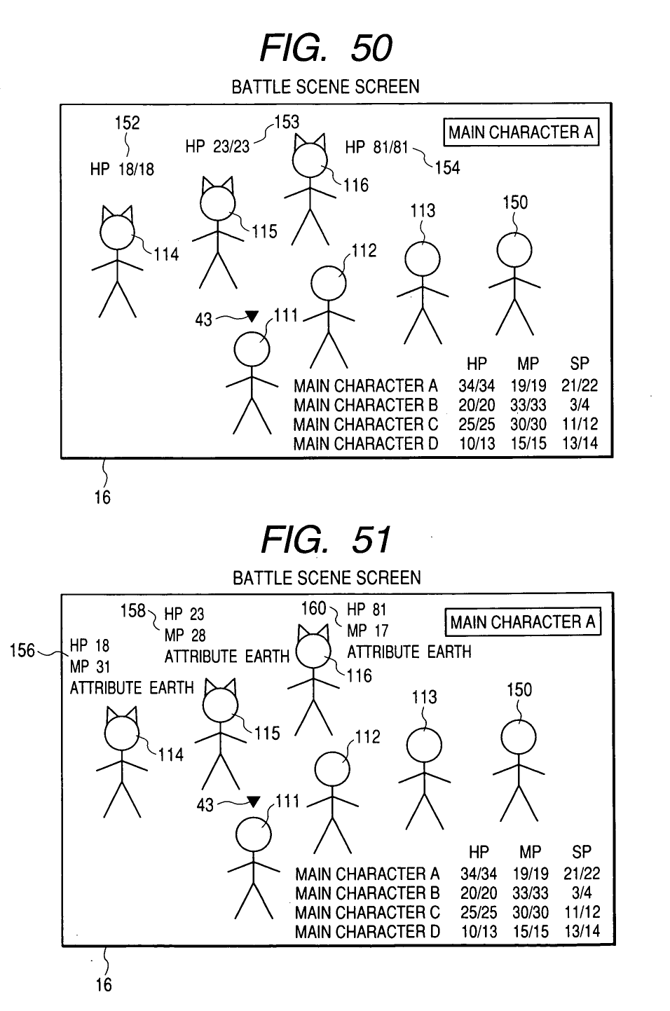

FIG. 50 shows an example of a screen displaying the maximum HP and the remaining HP of each monster as the maximum HP/remaining HP display processing (ST142) is performed. It shows that the main character D 150 having the skill of displaying the information concerning the monster with which the main character fights a battle is displayed in addition to the main character A 111, the main character B 112, and the main character C 113 as the main characters and takes part in the battle. HP 152 of the enemy character A 114 is displayed in the form of current value/maximum value in the vicinity of the enemy character A 114. Likewise, HP 153 of the enemy character B 115 and HP 154 of the enemy character C 116 are also displayed. As the HPs of the enemy characters are thus displayed, the player can previously know whether or not the opposite character is easy to beat in the battle and how much labor is required for beating the opposite character. For example, the screen in FIG. 50 displays that the current value of the HP of the enemy character A 114 is 18 and that the current value of the HP of the enemy character C 116 is 81. The display enables the player to understand that the enemy character A 114 is easy to beat and it takes labor and time in beating the enemy character C 116 and the action power of the main character should be raised before taking action. Some monsters provide a special profit, namely, item for increasing the HP, MP, or SP of the main character when the monster is beaten. When the monster takes part in the battle, the main character D 150 also takes part in the battle, whereby the special profit (item) is displayed for enabling the player to easily determine the opposite character that the energies of the main character should particularly concentrate on beating.

In the display screen, the character for which command selection is made effective with display of the selection mark 43 is the main character A 111. That is, the main character A 111 rather than the main character D 150 takes action. However, when the main character D 150 takes part in the battle, although command selection for the main character D 150 is not effective, the information concerning the enemy characters can be disclosed and profit is given in determining the action of every allay main character. Thus, as the main character D 150 takes part in the battle, the bonus of displaying the information concerning the opposite character is given. The player advances the game with a sense of anticipation that the main character D 150 will take part in the battle as a member of the main characters.

FIG. 51 shows an example of a screen displaying the HP of each monster together with the MP and the attribute as the attribute display processing (ST141) is performed. It displays current values 156 of the maximum HP, the maximum MP, and the attribute of the enemy character A 114 in the vicinity of the enemy character A 114. Likewise, current values 158 of the maximum HP, the maximum MP, and the attribute of the enemy character B 115 and current values 160 of the maximum HP, the maximum MP, and the attribute of the enemy character C 116 are also displayed. As not only the HPs, but also the MPs and the attributes of the enemy characters are thus displayed, the player can previously know what are the weak points of the opposite characters in the battle.

The embodiment of the invention has been described, but the invention is not limited to the specific embodiment. For example, the controller 4 operated by the player may be made integral with the machine main unit 1.

Further, the invention can also be applied to a portable gaming machine or a desk-top gaming machine including in one piece an operation unit that can be operated by a player, a display section for displaying an image and audio (sound), a storage section for storing a gaming program, and a control section for executing control processing following the gaming program.

Further, the invention can also be applied to a network game of the type wherein the above-mentioned gaming program is stored in a server connected to a network such as the Internet and a player can play a game by connecting to the server from a personal computer, a mobile telephone, a portable information terminal (PDA), etc.

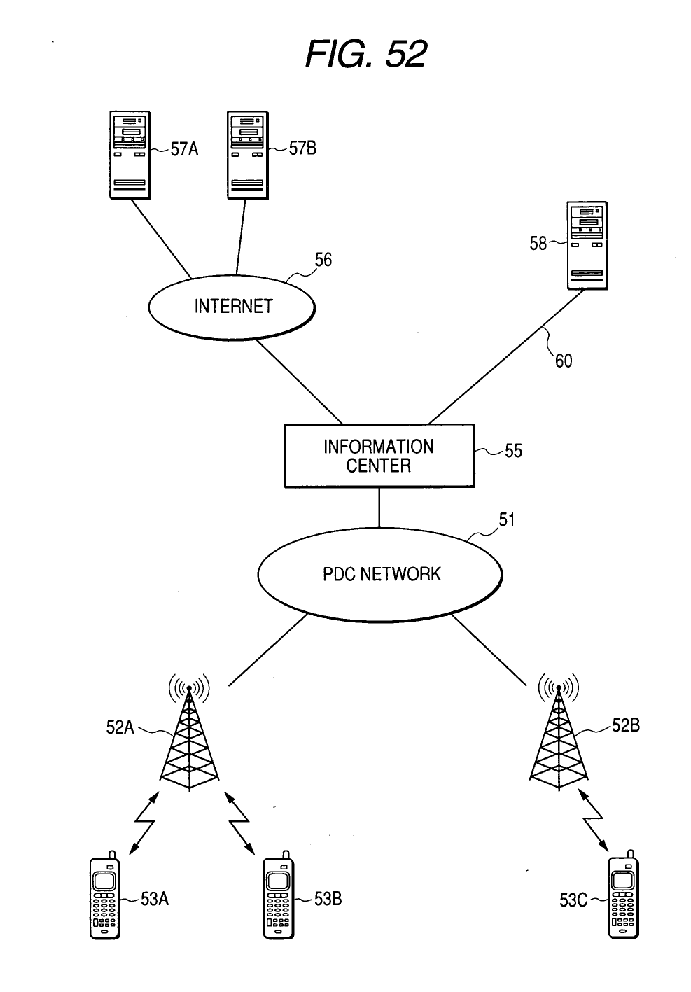

A network game system will be discussed with FIG. 52 by way of example. In the network game system, mobile telephones 53A, 53B, and 53C as terminals for playing a game are connected to a PDC network 51 capable of conducting packet communications, for example, through base stations 52A and 52B, and an information center 55 is accessed through the PDC network 51 in response to player's operation and the game state. The information center 55 acquires various pieces of information through a network such as Internet 56 from servers 57A and 57B storing data required for games and the like as well as game programs in response to requests from the mobile telephones 53A, 53B, and 53C, and transmits information required for games to the mobile telephones 53A, 53B, and 53C. Like a server 58 in FIG. 52, the server storing the game data, etc., may be connected to the information center 55 by a private or leased communication line 60 not via the network such the Internet 56.

To play a game, the player previously downloads a game program from the server 57A, 57B into the mobile telephone 53A, 53B, 53C and executes the game program on the mobile telephone 53A, 53B, 53C. In addition, various systems are possible, such as a system wherein the mobile telephone 53A, 53B, 53C is assigned a role like a browser in such a manner that the game program is executed on the server 57A, 57B in accordance with an instruction from the mobile telephone 53A, 53B, 53C and the player views the game on the mobile telephone 53A, 53B, 53C. The players may share the network game system or may be able to fight a battle with each other by connecting the mobile telephones using the PDC network 51.

In the picture book table corresponding to the PHOTOGRAPH command processing and the SUMMON command in the embodiment, the monsters can contain a fusion monster and the fusion monster can also be photographed and summoned. However, the fusion monster may be excluded from the monsters registered in the picture book table as a special type of monster to which the PHOTOGRAPH command cannot be applied.

The type of skill of each monster stored in the monster table is attack spell. However, the skill of each monster is not limited to the attack spell and may be recovery spell used to recover the HP or Mp of any other main character or status spell to recover the status.

As the PHOTOGRAPH command processing, monster data is stored unconditionally in the picture book table when the PHOTOGRAPH command is selected. However, the condition to store the monster data in the picture book table is not necessarily limited to selection of the PHOTOGRAPH command. For example, after selection of the PHOTOGRAPH command, the judgment ring and the rotation bar are displayed and if the player always succeeds in operating the controller at the timing at which the rotation bar corresponding to each area of the judgment ring, the parameters of the target monster may be transferred from the monster table to the picture book table. Accordingly, the operation technique of the player is involved in whether or not the PHOTOGRAPH command can be executed, and the interest in the game is augmented because of technical intervention.

When the SUMMON command is selected, the monsters that can be summoned may be limited to some depending on the skill value rather than all of the monsters stored in the picture book. However, to limit the monsters that can be summoned, any other parameter belonging to each monster may be used. For example, an encounter percentage parameter indicating the battle encounter percentage with an enemy may be set for each monster and only the monsters with the encounter percentage less than 1% may be made able to be used. Accordingly, the monster usually appearing at a low frequency can be often used in the SUMMON command processing.

As described above, according to the invention, the special skill not essentially provided for the character can be used by referencing the special skill parameter and the special skill is given according to predetermined entry operation, so that it is made possible to acquire the special skill without special labor. Therefore, it is made possible for the character to use the special skill independently of the level of the character, the action variations increase, and pleasure of collecting the special skills is added. The interest in the game can also be augmented.

According to the invention, an ally character and an enemy character are displayed on the screen and as a predetermined condition is satisfied, the status of the enemy character is displayed. Therefore, it is made possible for the player to fight a battle with the enemy character having a better condition and the flexibility of a battle is widened.

As described above, the computer executing the program according to the embodiment stores the parameter of a technique belonging to a different character according to predetermined entry operation for the character whose action is determined in response to entry operation through the operation unit, whereby the special skill is given to the character. To determine the action of the character, the special skill based on the stored parameter can be used. Thus, to determine the action of one character, the special skill not essentially provided for the character can be adopted. Moreover, the special skill is stored according to predetermined entry operation, so that the player can be given the special skill without operation labor of an event such as beating the enemy character in a battle, for example. Therefore, it is made possible for the character to use the special skill used by the enemy character independently of the battle skill level of the character or the operation skill of the player. The action variations increase, pleasure of collecting the special skills is added, and the effects using the technique of attack spell in a battle also become multifaceted; the interest in the game can be augmented. The player fights a battle with the enemy character with a sense of anticipation that a special skill will be given, and the interest of the player in the battle scene can be increased. The ally character corresponds to the main character in the embodiment. The parameters of the techniques correspond to various parameters of spell stored in a monster table and a picture book table. The special skill giving means corresponds to PHOTOGRAPH command processing (ST77) in the embodiment and the action determination means corresponds to command processing (ST35).

According to the embodiment, in an RPG (role playing game) wherein a plurality of characters take action in order, after the special skill giving means gives the special skill, the action determination means enables the character to use the special skill. Thus, the character can use the special skill from action in the turn just after the special skill is given. Therefore, the special skill can be used immediately after it is acquired, so that the possibility that the player may advance the battle advantageously becomes high. Since the player can play a game using a special skill, such as spell attack, after starting the game, multifaceted effects can be produced.

According to the embodiment, a character in an RPG can take action using a special skill not essentially provided for the character. Moreover, the special skill is given according to predetermined entry operation, so that the player can get the special skill without operation labor of beating the enemy character, etc., required in the RPG. Therefore, it is made possible for the character to use the special skill independently of the level of the character, so that the action variations increase and pleasure of collecting the special skills is added. The effects of attack spell also become multifaceted, and the interest in the game can be augmented.

According to the embodiment, the computer executing the program of the invention provides an RPG for displaying an ally character and an enemy character on the screen and advancing the game on the screen in response to entry operation. The computer stores the parameter of the status of the enemy character in the storage section and displays the status on the screen based on the stored parameter as a predetermined condition is satisfied. The status of the enemy character is HP, MP, and a special profit for increasing the points of the ally character beating the enemy character, for example. Since the status of the enemy character is displayed, the player easily determines the opposite character that the energies of the ally character should particularly concentrate on beating.

In the embodiment, the enemy character status display control means can also display the status of the enemy character based on the parameter stored in the storage section according to a predetermined condition different from entry operation through the operation unit for determining the action of the ally character. The action determined for the ally character is an attack on the enemy character. Therefore, the computer can display the status of the enemy character according to a condition different from entry operation for determining the action, for example, according to different specific entry operation. Therefore, the player can know the status of the enemy character without performing operation for attack. The player can previously select the enemy character involving any desired bonus item, for example, for fighting a battle. The ally character corresponds to the main character in the embodiment. The action determination means corresponds to command processing (ST35) in the embodiment, and the enemy character status display control means corresponds to HP display processing (ST138 to ST142).

According to the embodiment, when a specific character is displayed, the enemy character status display control means can display the status of the enemy character without special operation of the player. Accordingly, the status of the enemy character can be displayed without performing special operation, such as attack operation. Therefore, the player can previously select the enemy character involving any desired bonus item, for example, for fighting a battle. The possessed points usually consumed by way of compensation for attack action of spell attack, etc., are not consumed, so that the player can advance the battle advantageously.

According to the embodiment, the enemy character status display control means displays the status when the action is determined. Accordingly, when the battle with the enemy character is not complete, it is made possible to display the status of the enemy character. Therefore, the player is informed of the status of the enemy character before the battle is complete, and the player can obtain guides for the labor and the time to completion of the battle.

According to the embodiment, the enemy character status display control means displays the attack resistance indicator, such as the maximum hit points or the remaining hit points, indicating the resistance to an attack as the status of the enemy character. Accordingly, for example, when the enemy character having a high attack resistance indicator is attacked, the player can forecast the guide for the time to the termination of the battle. The player can be made to concentrate on the game with the guide for the time to the termination of the battle.

According to the embodiment, as the predetermined condition is satisfied in an RPG, the status of the enemy character is displayed, so that the player easily determines the opposite character that the energies of the ally character should particularly concentrate on beating.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

What is claimed is:

1. A gaming machine for allowing a player to enter an action command of an ally character to proceed a game, the gaming machine comprising:
an operation unit that allows the player to enter the action command;
a display controller that displays a plurality of characters including the ally character and at least one enemy character on a display for displaying the progress of the game and displaying a battle between the ally character and the enemy character; and
an enemy parameter storage that stores a parameter concerning the enemy character when the ally character encounters the enemy character and a predetermined condition is satisfied.

2. The gaming machine as claimed in claim 1, wherein when the ally character encounters the enemy character and wins a battle with the enemy character, the enemy parameter storage stores the parameter concerning the enemy character.

3. The gaming machine as claimed in claim 1, wherein when the ally character encounters the enemy character and executes predetermined action, the enemy parameter storage stores the parameter concerning the enemy character.

4. The gaming machine as claimed in claim 3, wherein when the ally character encounters the enemy character and executes action of taking a photograph of the enemy character, the enemy parameter storage stores the parameter concerning the enemy character.

5. The gaming machine as claimed in claim 1, wherein the display controller displays the parameter concerning the enemy character stored in the enemy parameter storage in response to a display request entered in the operation unit by the player.

6. The gaming machine as claimed in claim 1, wherein when the ally character encounters the enemy character with the parameter stored in the enemy parameter storage and a predetermined condition is satisfied, the display controller references the parameter concerning the enemy character stored in the enemy parameter storage and displays the parameter during the battle.

7. The gaming machine as claimed in claim 6, wherein when the ally character encounters the enemy character with the parameter stored in the enemy parameter storage and a predetermined ally character takes part in the battle, the display controller displays the parameter concerning the enemy character during the battle.

8. The gaming machine as claimed in claim 6, wherein while the ally character encounters the enemy character with the parameter stored in the enemy parameter storage and the player operates the operation unit for selecting the action to be executed for a predetermined ally character during the battle, the display controller displays the parameter concerning the enemy character.

9. The gaming machine as claimed in claim 6, wherein when the ally character encounters the enemy character with the parameter stored in the enemy parameter storage and the predetermined condition is satisfied, the display controller displays an attack resistance indicator indicating the resistance of the enemy character to attack of the ally character together with the parameter.

10. The gaming machine as claimed in claim 1, wherein the enemy parameter storage stores information containing the type of enemy character, a special skill of the enemy character, and skill value of the enemy character as the parameters concerning the enemy character.

11. The gaming machine as claimed in claim 1 further comprising an action determination section that determines the action of the ally character in the battle based on the operation command entered in the operation unit,
wherein the action determination section presents a special skill belonging to the enemy character with the parameter stored in the enemy parameter storage to the player as one of actions that can be selected by the ally character.

12. The gaming machine as claimed in claim 11, wherein the enemy character include a normal enemy character and a special enemy character each belonging to at least one attribute, the gaming machine further comprising:
an attribute value table storage section that stores an attribute value table for storing the attribute value acquired when the ally character wins the battle with the normal enemy character for each attribute;
an attribute value addition section that refers, when the ally character wins the battle with the normal enemy character, the attribute value table stored in the attribute value table storage section and adding the attribute value acquired by the ally character for each attribute; and
a battle execution section that executes a battle between the ally character and the special enemy character when the attribute value provided by the attribute value addition section reaches a predetermined value,
wherein when a predetermined condition is satisfied as the result of the battle executed by the battle execution section, the enemy parameter storage stores the parameter concerning the special enemy character.

13. The gaming machine as claimed in claim 12, wherein when the ally character wins the battle with the special enemy character, the enemy parameter storage stores the parameter concerning the special enemy character.

14. The gaming machine as claimed in claim 12, wherein when the ally character executes predetermined action, the enemy parameter storage stores the parameter concerning the special enemy character.

15. The gaming machine as claimed in claim 14, wherein when the ally character executes action of taking a photograph of the special enemy character, the enemy parameter storage stores the parameter concerning the special enemy character.

16. A computer-readable program product for storing a gaming program for causing a computer to execute the steps of:
allowing a player to enter an action command of an ally character to proceed a game;
displaying a plurality of characters including the ally character and at least one enemy character on a display for displaying the progress of the game and displaying a battle between the ally character and the enemy character; and
storing a parameter concerning the enemy character in an enemy parameter table when the ally character encounters the enemy character and a predetermined condition is satisfied.

17. The program product as claimed in claim 16, wherein when the ally character encounters the enemy character and wins a battle with the enemy character, the parameter concerning the enemy character is stored in the enemy parameter table.

18. The program product as claimed in claim 16, wherein when the ally character encounters the enemy character and executes predetermined action, the parameter concerning the enemy character is stored in the enemy parameter table.

19. The program product as claimed in claim 18, wherein when the ally character encounters the enemy character and executes action of taking a photograph of the enemy character, the parameter concerning the enemy character is stored in the enemy parameter table.

20. The program product as claimed in claim 16 further including a step of displaying the parameter concerning the enemy character stored in the enemy parameter table in response to a display request from the player.

21. The program product as claimed in claim 16 further including a step of referencing the parameter concerning the enemy character stored in the enemy parameter table and displaying the parameter during the battle when the ally character encounters the enemy character with the parameter stored in the enemy parameter table and a predetermined condition is satisfied.

22. The program product as claimed in claim 21, wherein when a predetermined ally character takes part in the battle, the parameter concerning the enemy character is displayed during the battle.

23. The program product as claimed in claim 21, wherein in displaying the parameter concerning the enemy character during the battle, while the ally character encounters the enemy character with the parameter stored in the enemy parameter table and the player performs selection operation of the action to be executed for the predetermined ally character during the battle, the parameter concerning the enemy character is displayed.

24. The program product as claimed in claim 21, wherein in displaying the parameter concerning the enemy character during the battle, when the ally character encounters the enemy character with the parameter stored in the enemy parameter table and the predetermined condition is satisfied, an attack resistance indicator indicating the resistance of the enemy character to attack of the ally character is displayed together with the parameter.

25. The program product as claimed in claim 16, wherein in storing the parameter concerning the enemy character, information containing the type of enemy character, a special skill of the enemy character, and skill value of the enemy character is stored as the parameters concerning the enemy character.

26. The program product as claimed in claim 16 further including a step of determining the action of the ally character in the battle based on the operation command entered by the player,
wherein in determining the action of the ally character, a special skill belonging to the enemy character with the parameter stored in the enemy parameter table is presented to the player as one of actions that can be selected by the ally character.

27. The program product as claimed in claim 26, wherein the enemy character include a normal enemy character and a special enemy character each belonging to at least one attribute, the program product further including steps of:
storing the attribute value acquired when the ally character wins the battle with the normal enemy character in the attribute value table for each attribute;
referencing, when the ally character wins the battle with the normal enemy character, the attribute value table and adding the attribute value acquired by the ally character for each attribute; and
executing a battle between the ally character and the special enemy character when the provided attribute value reaches a predetermined value,
wherein in storing the parameter concerning the enemy character, when a predetermined condition is satisfied as the result of the battle between the ally character and the special enemy character, the parameter concerning the special enemy character is stored.

28. The program product as claimed in claim 27, wherein when the ally character wins the battle with the special enemy character, the parameter concerning the special enemy character is stored.

29. The program product as claimed in claim 28, wherein when the ally character executes predetermined action, the parameter concerning the special enemy character is stored.

30. The program product as claimed in claim 29, wherein when the ally character executes action of taking a photograph of the special enemy character, the parameter concerning the special enemy character is stored.

31. A gaming program that is executed by a computer including operation means operated by a player and a storage means that stores a parameter, for displaying a plurality of characters on a screen of an existing display or a separate display and determining an action for any of the plurality of characters in response to entry operation through the operation means to proceed a game on the screen, the gaming program for causing the computer to function as
special skill giving means for storing a parameter of a skill belonging to a different character from the character whose action is determined according to predetermined entry operation through the operation means in the storage section as a special skill parameter; and
action determination means for determining the action of the character using the special skill parameter stored in the storage section in response to entry operation through the operation means.

32. The gaming program as claimed in claim 31 for further causing the computer to function so as to select the characters whose action is determined by the action determination means in a predetermined order,
wherein after the special skill parameter is stored by the special skill giving means, the action determination means enables the selected character to use the special skill parameter.

33. A gaming machine comprising:
operation means that is operated by a player; and
a machine main unit that displays a plurality of characters on a screen of an existing display or a separate display and determining an action for any of the plurality of characters in response to entry operation through the operation means to proceed a game on the screen,
wherein the machine main unit comprises:
storage means for storing parameters of the characters;
special skill giving means for storing a parameter of a technique belonging to a different character from the character whose action is determined according to predetermined entry operation through the operation means in the storage means as a special skill parameter; and
action determination means for determining the action of the character using the special skill parameter stored in the storage means in response to entry operation through the operation means.

34. A computer-readable storage medium recording a gaming program that is executed by a computer including operation means that is operated by a player and a storage section that stores a parameter, for displaying a plurality of characters on a screen of an existing display or a separate display and determining an action for any of the plurality of characters in response to entry operation through the operation means to proceed a game on the screen, the gaming program for causing the computer to function as
special skill giving means for storing a parameter of a technique belonging to a different character from the character whose action is determined according to predetermined entry operation through the operation means in the storage section as a special skill parameter; and
action determination means for determining the action of the character using the special skill parameter stored in the storage section in response to entry operation through the operation means.

35. A gaming program that is executed by a computer including operation means that is operated by a player and a storage section that stores a parameter, for displaying an ally character and an enemy character on a screen of an existing display or a separate display and determining an action for the ally character in response to entry operation through the operation means to proceed a game on the screen, the gaming program comprising the steps of causing the computer to operate as
action determination means for determining the action of the ally character in response to entry operation through the operation means;
status parameter acquisition means for storing a parameter of the status of the enemy character in the storage section; and
enemy character status display control means for displaying the status on the screen based on the parameter stored in the storage section as a predetermined condition is satisfied.

36. The gaming program as claimed in claim 35 wherein different types of ally characters that can be displayed on the screen exist,
wherein the predetermined condition is the case where a predetermined ally character of the different types of ally characters takes part in a battle between the ally character and the special enemy character.

37. The gaming program as claimed in claim 35, wherein the enemy character status display control means displays the status when the action is determined for the specific ally character.

38. The gaming program as claimed in claim 35, wherein the status displayed by the enemy character status display control means includes an attack resistance indicator indicating the resistance to an attack received from the ally character.

39. A gaming machine comprising:
operation means that is operated by a player; and
a machine main unit that displays an ally character and an enemy character on a screen of an existing display or a separate display and determining an action for the ally character in response to entry operation through the operation means to proceed a game on the screen,
wherein the machine main unit comprises:
action determination means for determining the action of the ally character in response to entry operation through the operation means;
status parameter storage means for storing a parameter of the status of the enemy character; and
enemy character status display control means for displaying the status on the screen based on the parameter stored in the status parameter storage means as a predetermined condition is satisfied.

40. A computer-readable storage medium recording a gaming program that is executed by a computer including operation means that can be operated by a player for displaying an ally character and an enemy character on a screen of an existing display or a separate display and determining an action for the ally character in response to entry operation through the operation means to proceed a game on the screen, the gaming program comprising the steps of causing the computer to operate as
action determination means for determining the action of the ally character in response to entry operation through the operation means;
status parameter storage means for storing a parameter of the status of the enemy character; and
enemy character status display control means for displaying the status on the screen based on the parameter stored in the status parameter storage means according to specific entry operation different from the entry operation.
